(19) United States
(12) Patent Application Publication
(10) Pub. No.: US 2024/0425014 A1
(43) Pub. Date: Dec. 26, 2024

(54) DESIGNATED DRIVER MANAGEMENT SYSTEM BASED ON BIOMETRIC IDENTIFICATION TECHNOLOGY

(71) Applicant: THE THIRD RESEARCH INSTITUTE OF MINISTRY OF PUBLIC SECURITY, Shanghai (CN)

(72) Inventor: Caixia Liu, Shanghai (CN)

(21) Appl. No.: 18/708,194

(22) PCT Filed: Nov. 4, 2022
(86) PCT No.: PCT/CN2022/129877

§ 371 Date: May 7, 2024

(30) Foreign Application Priority Data
Jun. 7, 2022 (CN) 202210642196.9

(51) Int. Cl. B60R 25/25; B60R 25/102; G06F 21/32; G06V 40/70

(52) U.S. Cl. CPC B60R 25/252; B60R 25/102; G06F 21/32; G06V 40/70

(57) ABSTRACT

A specified driver management system based on biometric identification technology is provided. The system reads a document held by a driver and acquire biometric information of the driver by a driver identity verification unit, then performs on-site person-document consistency verification and performs comparison with biometric information corresponding to identity information of an authorized driver, thereby finishing driver identity verification. The identity verification result is linked to a vehicle control unit, to determine whether the vehicle is permitted to start. The system binds the driver identity with drive permission of an operating vehicle, and controls start permission of the vehicle and/or generate a safety warning to an illegal driver according to the driver identity verification result. This guarantees the driving safety of operating vehicles such as “Tourist Chartered Buses, Liner Buses, and Dangerous Goods Transport Vehicles” from the perspective of drivers.

### CROSS-REFERENCE TO RELATED APPLICATIONS

The present application is a National Stage application of PCT international application: PCT/CN2022/129877, filed on 4 Nov. 2022, the disclosure of which is hereby incorporated by reference in its entirety.

### TECHNICAL FIELD

The present disclosure relates to vehicle transportation safety monitoring technologies, in particular to, safety monitoring of operating vehicles that require driver qualification management, such as road passenger transport vehicles, tourist vehicles, hazardous materials transport vehicles, freight vehicles, school buses.

### BACKGROUND

“Tourist Chartered Buses, Liner Buses, Dangerous Goods Transport Vehicles, Freight Vehicles, and School Buses” refer to chartered buses for tourist, liner buses of class III or above, dangerous goods transport vehicles for transporting hazardous chemicals, fireworks, and/or civilian explosives, operating vehicles for carrying goods, and passenger vehicles with more than seven seats that take students receiving compulsory education to and from school. Once these types of vehicles have traffic accidents, serious consequences are often caused. Therefore, the “Tourist Chartered Buses, Liner Buses, Dangerous Goods Transport Vehicles, Freight Vehicles, and School Buses” vehicles have been listed as key control objects by relevant industry departments, and accordingly need strict monitoring.

The “Tourist Chartered Buses, Liner Buses, Dangerous Goods Transport Vehicles, Freight Vehicles, and School Buses” vehicles have relatively high requirements on driving license quasi-driving types, practical driving skills, and professional qualifications of drivers. The actual drivers of these types of vehicles need to be the specified drivers who are authorized.

However, according to the transportation industry standards JT/T 794-2019, Global Navigation Satellite System (GNSS) for operating vehicles-Technical specifications for vehicle terminals, driver identity confirmation is only carried out through driver identity identification using an integrated circuit (IC) card qualification certificate of the driver, without verifying whether the certificate is in the possession of the driver. Therefore, there is a risk that an unqualified driver uses another driver's IC card qualification certificate to illegally drive the operating vehicles.

Therefore, it is an urgent problem that how to accurately verify the driver identity of each type of operating vehicle through effective technical means, to perform effective monitoring and active intervention of potential accident risks caused by drivers, thereby improving the driving safety of all types of operating vehicles.

### SUMMARY

In view of the problems in the existing safety supervision technology for operating vehicles, especially the driver identity verification technology, there is a need to provide a novel driver identity verification technology for operating vehicle safety supervision, to realize effective monitoring and active intervention of accident risks caused by drivers, so as to overcome the defects in the existing safety supervision technology for operating vehicles, thereby making up for risks in the existing application solutions, and eliminating safety hazards caused by drivers.

Therefore, the present disclosure aims to provide a specified or designated driver management system based on biometric identification technology. The system performs dual-verification for driver identity, including on-site 1:1 person-document consistency verification, and on-site or remote 1:N (N:1 to n) specified driver verification, and links the verification result with the vehicle control system, which improves the driving safety of the vehicle.

In order to achieve the above objectives, the present disclosure provides a specified driver management system based on biometric identification technology, including a driver identity verification unit, a vehicle control unit, a vehicle gateway unit, an alarm prompt unit, and a remote management unit.

The driver identity verification unit is disposed in a cab of a vehicle. It is associated with the vehicle gateway unit, the vehicle control unit, and the alarm prompt unit, and is associated with the remote management unit and/or the vehicle control unit and/or the alarm prompt unit through the vehicle gateway unit. The driver identity verification unit is able to acquire document information and biometric information of a current driver. The driver identity verification unit itself can store the acquired document information and biometric information of the current driver, and identity information and corresponding biometric information of an authorized driver, and perform consistency verification on the biometric information in the acquired document information of the driver and the biometric information acquired on site, and perform comparison verification on the biometric information and the information of the authorized driver. Alternatively, the driver identity verification unit may store the acquired document information and biometric information of the current driver, and the identity information and the corresponding biometric information of an authorized driver in a data storage module of the vehicle gateway unit, so that the vehicle gateway unit performs consistency verification on the biometric information in the acquired document information of the driver and the biometric information acquired on site, and performs comparison verification on the biometric information and the information of the authorized driver. Alternatively, the driver identity verification unit wirelessly uploads the acquired document information and biometric information of the current driver to the remote management unit through a network communication module of the vehicle gateway unit, and the remote management unit stores the identity information and the corresponding biometric information of an authorized driver, so that the remote management unit performs consistency verification on the biometric information in the acquired document information of the driver and the biometric information acquired on site, and performs comparison verification on the biometric information and the information of the authorized driver. The driver identity verification unit controls a working state of a vehicle start system according to a verification result.

The vehicle control unit is disposed in the cab or the engine compartment of the vehicle, and is linked with the vehicle start system. It is associated with the vehicle gateway unit and the driver identity verification unit, and is associated with the alarm prompt unit, the remote management unit and/or the driver identity verification unit through the vehicle gateway unit. The vehicle control unit controls whether the vehicle is permitted to start according to the driver identity verification result sent by the driver identity verification unit or the vehicle gateway unit. The vehicle gateway unit is associated with the driver identity verification unit, the vehicle control unit, the alarm prompt unit, and the remote management unit respectively. The vehicle gateway unit is able to perform driver identity verification in cooperation with the driver identity verification unit. The vehicle gateway unit is disposed in the cab of the vehicle, and is associated with the driver identity verification unit, the vehicle control unit, the alarm prompt unit, and the remote management unit respectively. The vehicle gateway unit at least has a network communication function, a data storage function, and/or an edge computing function. It establishes a communication channel with the remote management unit, to perform comparison, identification, and analysis on the data information generated by the driver identity verification unit, or transmit the relevant information to the remote management unit for comparison, identification, and analysis, and transmit the management data information returned by the remote management unit to the vehicle control unit and the alarm prompt unit.

The alarm prompt unit is disposed in the cab of the vehicle or outside the vehicle, and is connected to the driver identity verification unit and the vehicle gateway unit. The alarm prompt unit is configured to issue a voice prompt or an audible and visual alarm according to the driver identity verification result sent by the driver identity verification unit or the vehicle gateway unit.

The remote management unit performs the driver identity verification in cooperation with the driver identity verification unit through the vehicle control unit, and outputs a corresponding control command for vehicle management and driver management to the vehicle gateway unit. The remote management unit is disposed in a cloud platform and/or a local storage server and/or a personal hand-held intelligent terminal of a relevant management person of a vehicle transportation related government department, or in a cloud platform and/or a local storage server and/or a personal hand-held intelligent terminal of a relevant management person of a vehicle transportation enterprise and a transportation related party, or in a personal hand-held intelligent terminal of a driver and passenger. The remote management unit is associated with the vehicle gateway unit. The remote management unit receives the specified driver identity verification result sent by the vehicle gateway unit, and generates the control command for vehicle management and driver management, or receives the identity information acquisition result of the current driver sent by the vehicle gateway unit, performs comparison identification on the identity information of the driver or the consistency between the identity information and the biometric information, or the relevant identity information, the biometric information and the official file database information, and the file information of the unit to which the driver belongs, and generates the control command for driver management and driver management. The control command is sent to the vehicle gateway unit, and is then sent to the alarm prompt unit or the vehicle control unit through the vehicle gateway unit, so as to issue the audible and visual alarm, the voice prompt, or control the vehicle.

Further, the driver identity verification unit includes an identity document reading sub-unit, a biometric information acquisition sub-unit, and a biometric information comparison sub-unit.

The identity document reading sub-unit is configured to obtain the identity information of the document held by the current driver and/or the biometric information in the document chip or on the document surface, and send the identity information of the document held by the current driver and/or the biometric information in the document chip or on the document surface to the biometric information comparison sub-unit in the driver identity verification unit, or the biometric information comparison sub-unit (such as the corresponding edge computing module) in the vehicle gateway unit, or the biometric information comparison sub-unit in the remote management unit through the vehicle gateway unit.

The biometric information acquisition sub-unit is configured to obtain the biometric information of the current driver, and send the obtained information to the biometric information comparison sub-unit in the driver identity verification unit, or the biometric information comparison sub-unit (such as the corresponding edge computing module) in the vehicle gateway unit, or the biometric information comparison sub-unit in the remote management unit through the vehicle gateway unit.

The biometric information comparison sub-unit is configured to perform comparison verification on the obtained biometric information corresponding to the identity information of the document held by the driver and the biometric information of the current driver, to determine whether the information belong to the same person and belong to an authorized driver, and perform secondary specified driver comparison verification on the identity information and the biometric information of the document held by the current driver that has passed on-site person-document consistency verification with driver identity information and biometric information stored in an authorized driver database in itself or the biometric information comparison sub-unit in the vehicle gateway unit or the biometric information comparison sub-unit in the remote management unit.

Further, the identity document reading sub-unit in the driver identity verification unit includes but is not limited to a second-generation resident identity card reading device, an IC card qualification certificate reading device, and/or a motor vehicle driving license reading device, and/or another document (such as a pass) reading device.

Further, the biometric information acquisition sub-unit in the driver identity verification unit includes but is not limited to a face information acquisition device, and/or a fingerprint information acquisition device, and/or an iris information acquisition device, and/or a finger vein information acquisition device, and/or a palm vein information acquisition device, and/or a palm print information acquisition device, and/or a retina information acquisition device, and/or a sound information acquisition device, or another biometric information (such as skin or palm geometric feature) acquisition device.

The face information acquisition device is configured to acquire frontal face information of the driver. The form of the face information acquisition device includes but is not limited to an external video capture camera and an embedded video capture camera. The type of the face information acquisition device includes but is not limited to a visible light video capture camera, a near-infrared video capture camera, a dedicated camera or a three-dimensional face acquisition instrument for acquiring three-dimensional face information.

The fingerprint information acquisition device is configured to acquire fingerprint information of the driver. The form of the fingerprint information acquisition device includes but is not limited to an external fingerprint collector, an embedded fingerprint acquisition component. The type of the fingerprint information acquisition device includes but is not limited to an optical fingerprint collector, a thermal fingerprint collector, and a biometric radio frequency fingerprint collector.

The iris information acquisition device is configured to acquire iris information of the driver. The form of the iris information acquisition device includes but is not limited to an external iris collector and an embedded iris collector. The type of the iris information acquisition device includes but is not limited to a monocular iris acquisition instrument (collector) and a binocular iris acquisition instrument (collector).

The finger vein information acquisition device is configured to acquire finger vein information of the driver. The form of the finger vein information acquisition device includes but is not limited to an external finger vein collector and an embedded finger vein acquisition component. The type of the finger vein acquisition device includes but is not limited to a single finger vein collector and a composite collector of finger vein plus finger print.

The palm vein information acquisition device is configured to acquire palm vein information of the driver. The form of the palm vein information acquisition device includes but is not limited to an external desktop palm vein collector, an external hand-held palm vein collector, and an embedded palm vein acquisition component. The type of the palm vein information acquisition device includes but is not limited to a single palm vein collector and a composite collector of palm vein plus palm print.

The palm print information acquisition device is configured to acquire palm print information of the driver. The form of the palm print information acquisition device includes but is not limited to an external desktop palm print collector, an external hand-held palm print collector, and an embedded palm print acquisition component. The type of the palm print information acquisition device includes but is not limited to a single palm print collector and a composite collector of palm print plus palm vein.

The retina information acquisition device is configured to acquire retina information of the driver. The specific form of the retina information acquisition device includes but is not limited to an external retina acquisition instrument and an embedded retina collector. The type of retina information acquisition device includes but is not limited to a monocular retina acquisition instrument (collector) and a binocular retina acquisition instrument (collector).

The sound information acquisition device is configured to acquire sound information of the driver. The form of the sound information acquisition device includes but is not limited to an external sound acquisition instrument and an embedded sound collector. The type of the sound information acquisition device includes but is not limited to a microphone, a mic, and a pickup.

The another biometric information (such as the skin or palm geometric feature) acquisition device is configured to acquire another biometric information of the driver, such as living body feature information inside the driver's skin, physical feature information of the driver's palm and finger. The form of the another biometric information (such as the skin or palm geometric feature) acquisition device includes but is not limited to an external acquisition instrument for another biometric information (such as the skin or palm geometric feature) and an embedded collector for another biometric information (such as the skin or palm geometric feature). Furthermore, the type of the another biometric information (such as the skin or palm geometric feature) acquisition device includes but is not limited to a skin light printing collector and a hand shape reader.

Further, the biometric information comparison sub-unit in the driver identity verification unit includes but is not limited to a face information comparison device, and/or a fingerprint information comparison device, and/or an iris information comparison device, and/or a finger vein information comparison device, and/or a palm vein information comparison device, and/or a palm print information comparison device, and/or a retina information comparison device, and/or a sound information comparison device, and/or another biometric information (such as the skin or palm geometric feature) comparison device.

The face information comparison device is configured to perform 1:1 comparison verification on the digital face photo in the chip and/or the face image on the surface of the read identify document or any other document and the face image information of the driver acquired on site, perform 1:1 comparison verification on the face image information of the driver acquired on site and the face information corresponding to the read identity in the database, and/or perform 1:N comparison verification on the face image information of the driver acquired on site and the face information of all authorized drivers in the database. The form of the face information comparison device includes but is not limited to an authorized person face database and a comparison identification component built in the identity verification unit, an authorized person face database and a comparison identification component in the vehicle gateway unit, and an authorized person face database and a comparison identification component in the remote management unit.

The fingerprint information comparison device is configured to perform 1:1 comparison verification on the fingerprint information in the chip of the read identity document or any other document and the fingerprint information of the driver acquired on site, perform 1:1 comparison verification on the fingerprint information of the driver acquired on site and the fingerprint information corresponding to the read identity in the database, and/or perform 1:N comparison verification on the fingerprint information of the driver acquired on site and the fingerprint information of all authorized drivers in the database. The form of the fingerprint information comparison device includes but is not limited to an authorized person fingerprint database and a comparison identification component built in the identity verification unit, an authorized person fingerprint database and a comparison identification component in the vehicle gateway unit, and an authorized person fingerprint database and a comparison identification component in the remote management unit.

The iris information comparison device is configured to perform 1:1 comparison verification on the iris information (if any) in the chip of the read identity document or any other document and the iris information of the driver acquired on site, and/or perform 1:1 comparison verification on the iris information of the driver acquired on site and the iris information corresponding to the read identity in the database, and/or perform 1:N comparison verification on the iris information of the driver acquired on site and the iris information of all authorized drivers in the database. The form of the iris information comparison device includes but is not limited to an authorized person iris database and a comparison identification component built in the identity verification unit, an authorized person iris database and a comparison identification component in the vehicle gateway unit, and an authorized person iris database and a comparison identification component in the remote management unit.

The finger vein information comparison device is configured to perform 1:1 comparison verification on the finger vein information (if any) in the chip of the read identity document or any other document and the finger vein information of the driver acquired on site, and/or perform 1:1 comparison verification on the finger vein information of the driver acquired on site and the finger vein information corresponding to the read identity in the database, and/or perform 1:N comparison verification on the finger vein information of the driver acquired on site and the finger vein information of all authorized drivers in the database. The form of the finger vein information comparison device includes but is not limited to an authorized person finger vein database and a comparison identification component built in the identity verification unit, an authorized person finger vein database and a comparison identification component in the vehicle gateway unit, and an authorized person finger vein database and a comparison identification component in the remote management unit.

The palm vein information comparison device is configured to perform 1:1 comparison verification on the palm vein information (if any) in the chip of the read identity document or any other document and the palm vein information of the driver acquired on site, and/or perform 1:1 comparison verification on the palm vein information of the driver acquired on site and the palm vein information corresponding to the read identity in the database, and/or perform 1:N comparison verification on the palm vein information of the driver acquired on site and the palm vein information of all authorized drivers in the database. The form of the palm vein information comparison device includes but is not limited to an authorized person palm vein database and a comparison identification component built in the identity verification unit, an authorized person palm vein database and a comparison identification component in the vehicle gateway unit, and an authorized person palm vein database and a comparison identification component in the remote management unit.

The palm print information comparison device is configured to perform 1:1 comparison verification on the palm print information (if any) in the chip of the read identity document or any other document and the palm print information of the driver acquired on site, and/or perform 1:1 comparison verification on the palm print information of the driver acquired on site and the palm print information corresponding to the read identity in the database, and/or perform 1:N comparison verification on the palm print information of the driver acquired on site and the palm print information of all authorized drivers in the database. The form of the palm print information comparison device includes but is not limited to an authorized person palm print database and a comparison identification component built in the identity verification unit, an authorized person palm print database and a comparison identification component in the vehicle gateway unit, and an authorized person palm print database and a comparison identification component in the remote management unit.

The retina information comparison device is configured to perform 1:1 comparison verification on the retina information (if any) in the chip of the read identity document or any other document and the retina information of the driver acquired on site, and/or perform 1:1 comparison verification on the retina information of the driver acquired on site and the retina information corresponding to the read identity in the database, and/or perform 1:N comparison verification on the retina information of the driver acquired on site and the retina information of all authorized drivers in the database. The form of the retina information comparison device includes but is not limited to an authorized person retina database and a comparison identification component built in the identity verification unit, an authorized person retina database and a comparison identification component in the vehicle gateway unit, and an authorized person retina database and a comparison identification component in the remote management unit.

The sound information comparison device is configured to perform 1:1 comparison verification on the sound information feature (if any) in the chip of the read identity document or any other document and the sound information feature of the driver acquired on site, and/or perform 1:1 comparison verification on the sound information feature of the driver acquired on site and the sound information feature corresponding to the read identity in the database, and/or perform 1:N comparison verification on the sound information feature of the driver acquired on site and the sound information features of all authorized drivers in the database. The form of the sound information comparison device includes but is not limited to an authorized person sound database and a comparison identification component built in the identity verification unit, an authorized person sound database and a comparison identification component in the vehicle gateway unit, and an authorized person sound database and a comparison identification component in the remote management unit.

The comparison device for another biometric information such as the skin or palm geometric feature is configured to perform 1:1 comparison verification on the another biometric information (if any) such as the skin or palm geometric feature in the chip of the read identity document or any other document and the another biometric information such as the skin or palm geometric feature of the driver acquired on site, and/or perform 1:1 comparison verification on the another biometric information such as the skin or palm geometric feature of the driver acquired on site and the another biometric information such as the skin or palm geometric feature corresponding to the read identity in the database, and/or perform 1:N comparison verification on the another biometric information such as the skin or palm geometric feature of the driver acquired on site and the another biometric information such as the skin or palm geometric feature of all authorized drivers in the database. The form of the comparison device for another biometric information such as the skin or palm geometric feature includes but is not limited to an authorized person database of another biometric information such as the skin or palm geometric feature and a comparison identification component built in the identity verification unit, an authorized person database of another biometric information such as the skin or palm geometric feature and a comparison identification component in the vehicle gateway unit, and an authorized person database of another biometric information such as the skin or palm geometric feature and a comparison identification component in the remote management unit.

Further, the driver identity verification unit is directly associated with the vehicle control unit or is indirectly associated with the vehicle control unit and/or the remote management unit through the vehicle gateway unit. In the case that the driver identity verification unit is directly associated with the vehicle control unit, the switch of the vehicle ACC can be activated normally after the specified driver identity verification passes; otherwise, the switch of the vehicle ACC cannot be activated normally, and the alarm prompt unit issues the verification failure alarm and prompts the driver to adjust the posture for re-acquiring the biometric feature. The verification result and the vehicle start condition are uploaded to the remote management unit through the vehicle gateway unit. In the case that the driver identity verification unit is indirectly associated with the vehicle control unit through the vehicle gateway unit, the vehicle gateway unit sends the command to the vehicle control unit after the driver identity verification result is generated. In the case that the verification passes, the switch of the vehicle ACC can be activated normally; otherwise, the switch of the vehicle ACC cannot be activated normally, and the alarm prompt unit issues the verification failure alarm and prompts the driver to adjust the posture for re-acquiring the biometric feature. The verification result and the vehicle start condition are uploaded to the remote management unit through the vehicle gateway unit. In the case that the driver identity verification unit is indirectly associated with the vehicle control unit through the vehicle gateway unit, and the biometric database and the comparison identification component are in the remote management unit, the identity document reading information and the biometric acquisition information of the current driver are uploaded to the remote management unit through the vehicle gateway unit. The remote management unit sends the verification result to the vehicle gateway unit after performing person-document consistency comparison based on the information acquired on site and comparison identification on the specified driver biometric information. The vehicle gateway unit sends the command to the vehicle control unit. The switch of the vehicle ACC can be activated normally in the case that the verification passes; otherwise, the switch of the vehicle ACC cannot be activated normally, and the alarm prompt unit sends the verification failure alarm and prompts the driver to adjust the posture for re-acquiring the biometric feature. The vehicle start condition is uploaded to the remote management unit through the vehicle gateway unit. In a special state, the driver identity verification unit supports remote emergency authorization through the remote management unit. After the emergency authorization, the switch of the vehicle ACC is in a normally on state, and can be activated directly without the driver identity verification.

Further, the vehicle control unit includes at least an adaptive cruise control (ACC) vehicle start control module.

The ACC vehicle start control module is configured to determine whether the vehicle is permitted to start after receiving the driver identity verification result sent by the driver identity verification unit or forwarded by the driver identity verification unit through the vehicle gateway unit. The vehicle is permitted to start in the case that the driver identity verification result is passed, and the vehicle is not permitted to start in the case that the driver identity verification result is failed.

Further, the vehicle control unit is directly associated with the driver identity verification unit and the vehicle gateway unit. In the case that the vehicle control unit receives the result that the driver identity verification passes or receives the result that the driver identity verification passes forwarded by the driver identity verification unit through the vehicle gateway unit, the vehicle control unit controls the vehicle ACC to be activated.

Further, the vehicle gateway unit includes a network communication module, and/or a data storage module, and/or an edge computing module.

The network communication module is configured to perform data exchange between the driver identity verification unit and the alarm prompt unit, the vehicle control unit, and the remote management unit. It forwards the identity document reading data, the biometric information acquisition data, or the identity verification result information uploaded by the driver identity verification unit to the remote management unit, or sends the corresponding command to the vehicle control unit and the alarm prompt unit according to the received driver identity verification result information; or sends the corresponding command to the vehicle control unit and the alarm prompt unit according to the driver identity verification result obtained by the edge computing module; or forwards the management command received from the remote management unit to the driver identity verification unit or the alarm prompt unit or the vehicle control unit.

The data storage module is configured to store the identity document reading data and the biometric information acquisition data uploaded by the driver identity verification unit or the identity information database and the biometric information database of authorized drivers.

The edge computing module is configured to perform consistency comparison on the identity document reading data and the biometric information acquisition data uploaded by the driver identity verification unit, and perform comparison verification with the information in the identity information database and the biometric information database of authorized drivers.

Further, the network communication module in the vehicle gateway unit includes a 5G communication device, a controller area network (CAN) bus communication device, a transmission control protocol/Internet protocol (TCP/IP) communication device, a Bluetooth communication device, and another wireless communication (such as Wi-Fi, Ultra-Wide Band (UWB), or Zigbee) device.

The 5G communication device is configured for communication between the vehicle gateway unit and the remote management unit.

The CAN bus communication device is configured for wired communication between the vehicle gateway unit and the driver identity verification unit, the alarm prompt unit, and the vehicle control unit in a CAN bus mode.

The TCP/IP communication device is configured for wired or wireless communication between the vehicle gateway unit and the driver identity verification unit, the alarm prompt unit, the vehicle control unit, and the remote management unit in a TCP/IP mode.

The Bluetooth communication device is configured for wireless communication based on the Bluetooth protocol between the vehicle gateway unit and the driver identity verification unit, and the alarm prompt unit.

The another wireless communication (such as WI-FI, UWB, or Zigbee) device is configured for wireless communication based on the corresponding protocol such as WI-FI, UWB, or Zigbee between the vehicle gateway unit and the driver identity verification unit, and the alarm prompt unit.

Further, the data storage module in the vehicle gateway unit includes a built-in data storage device and an external data storage device.

The built-in data storage device is configured to store the identity document reading data and the biometric information acquisition data uploaded by the driver identity verification unit, or the identity information database and the biometric information database of authorized drivers. The built-in data storage device includes but is not limited to a built-in static random-access memory (SRAM), a built-in dynamic RAM (DRAM), a built-in hard disk, and a built-in read-only memory (ROM). The built-in ROM is configured to store the identity information database and the biometric information database of authorized drivers.

The external data storage device includes but is not limited to an external mobile hard disk, a universal serial bus (USB) flash disk, a trans-flash (TF) memory card, a secure digital (SD) memory card, a compact disc-rewritable (CD-RW), a digital versatile disc (DVD)-RAM disc, a non-rewritable CD-ROM, a DVD-ROM disc. The non-rewritable CD-ROM and the DVD-ROM disc are configured to store the identity information database and the biometric information database of authorized drivers.

Further, the edge computing module in the vehicle gateway unit includes an artificial intelligence (AI) smart chip with an edge computing function or a terminal software development kit (SDK) with edge computing.

The circuit board AI smart chip with the edge computing function or the terminal SDK with edge computing is configured to perform consistency verification between the identity document reading data and the biometric information acquisition data uploaded by the driver identity verification unit, and perform comparison verification on the identity document reading data and the biometric information acquisition data with the information in the identity information database and the biometric information database of authorized drivers.

Further, the vehicle gateway unit is directly associated with the driver identity verification unit, the vehicle control unit, the alarm prompt unit, and the remote management unit.

Upon receiving the result that the specified driver identity verification passes, the vehicle gateway unit sends the command to the vehicle control unit to control the vehicle ACC to be activated, and forwards the driver identity verification result and the action information of the vehicle control unit to the remote management unit. Upon receiving the result that the specified driver identity verification fails, the vehicle gateway unit sends the command to the vehicle control unit to control the vehicle ACC to be deactivated, and sends the command to the alarm prompt unit to prompt the driver to adjust the posture for re-verification, and forwards the driver identity verification result and the action information of the vehicle control unit to the remote management unit.

Further, the alarm prompt unit includes vehicle local alarm prompt sub-units, such as an in-cab audible and visual alarm module, an in-cab voice prompt module, an out-of-cab audible and visual alarm module, and an out-of-cab voice prompt module, as well as remote monitoring client software alarm prompt sub-units, such as the government industry management client software, the enterprise operation management client software, and the driver and passenger service client software.

The in-cab audible and visual alarm module is configured to issue an audible and visual alarm in the case that the driver identity verification fails.

The in-cab voice prompt module is configured to prompt the driver to start the vehicle in the case that driver identity verification passes, and prompt the driver to adjust the posture for re-verification in the cast that the driver identity verification fails.

The out-of-cab audible and visual alarm module is configured to issue an audible and visual alarm to the crowd outside the vehicle in the case that the driver identity verification fails multiple times, or the vehicle ACC is forcibly activated without the driver identity verification under a non-emergency authorization state.

The out-of-cab voice prompt module is configured to issue an audible and visual alarm to the crowd outside the vehicle in the case that the driver identity verification fails multiple times, or the vehicle ACC is forcibly activated without the driver identity verification under a non-emergency authorization state. The volume of the voice prompt and the volume of the alarm sound are sufficient to alert pedestrians in noisy road environments, and the audio prompt content is broadcast clearly enough to make listeners understood.

The government industry management client software is configured to receive the alarm information forwarded by the vehicle gateway through the communication center in the case that the driver identity verification fails.

The enterprise operation management client software is configured to receive the alarm information forwarded by the vehicle gateway through the communication center in the case that the driver identity verification fails.

The driver and passenger service client is configured to receive the alarm information forwarded by the vehicle gateway through the communication center in the case that the driver identity verification fails. The driver and passenger service client issues the alarm information, and at the same time, issues a voice prompt. The content of the voice prompt varies depending on the user role of the driver and passenger service client. For example, the driver service client issues a voice prompt to prompt the driver to adjust the posture for re-verification.

Further, the alarm prompt unit is directly associated with the driver identity verification unit and the vehicle gateway unit. In the case that the vehicle local alarm prompt sub-unit receives the result that the driver identity verification fails sent by the driver identity verification unit or sent by the driver identity verification unit through the vehicle gateway unit, the vehicle local alarm prompt sub-unit issues an audible and visual alarm, and prompts the driver to adjust the posture for re-verification by voice.

In the case that the remote monitoring client software alarm prompt sub-unit receives the result that the driver identity verification fails sent by the driver identity verification unit or sent by the driver identity verification unit through the vehicle gateway unit and the communication center, the alarm prompt sub-unit issues an alarm prompt.

Further, the remote management unit includes the government industry management client software, the enterprise operation management client software, the driver and passenger service client software, and the communication center.

The government industry management client software is configured to receive and display the driver identity document acquisition result, the driver biometric information acquisition result, and the identity verification result sent by the driver identity verification unit or forwarded by the driver identity verification unit through the vehicle gateway unit and through the communication center, and perform the specified driver identity verification or the driver identity management according to the driver identity document acquisition result and the driver biometric information acquisition result.

The enterprise operation management client software is configured to receive and display the driver identity document acquisition result, the driver biometric information acquisition result, and the identity verification result sent by the driver identity verification unit or forwarded by the driver identity verification unit through the vehicle gateway unit and through the communication center, and perform the on-site person-document consistency comparison of the driver and the specified driver identity verification or the driver identity management according to the driver identity document acquisition result and the driver biometric information acquisition result.

The driver and passenger service client software is configured to receive and display the identity verification result sent by the driver identity verification unit or forwarded by the driver identity verification unit through the vehicle gateway unit and through the communication center, and issue a vehicle start prompt or a posture adjust prompt for re-verification according to the driver identity verification result.

The communication center is configured to communicate with the vehicle gateway unit, to receive and store the driver identity document acquisition result, the driver biometric information acquisition result, or the identity verification result forwarded by the driver identity verification unit through the vehicle gateway unit. In the case that the biometric information comparison component is disposed in the remote management unit, the biometric information comparison is performed by the cloud platform or the local server in the communication center. In addition, the communication center serves as the computer system environment for the government industry management client software, the enterprise operation management client software, and the driver and passenger service client software, to support relevant software applications, and forwards the management command or the response command of the government industry management client software, the enterprise operation management client software, and the driver and passenger service client software to the vehicle gateway unit.

Further, the government industry management client in the remote management unit includes public security industry management client software, traffic industry management client software, emergency industry management client software, and another industry management client software (such as an insurance industry management client software), depending on different industry departments.

The public security industry management client software is configured for driver identity verification management and driver identity management. The driver identity verification management can receive the driver and passenger identity verification result, and perform statistics and query. The driver identity management can receive the driver identify information and the identity verification result, and perform comparison analysis with the motor vehicle driving license file information in the public security organ. In the case that the driver identify information or the quasi-driving type is inconsistent with the driving license file information, or the quasi-driving type of the motor vehicle driving license corresponding to the driver identify information does not include the quasi-driving type required by the professional qualification, an alarm is issued by using text, image, voice, or file, to output warning information to the enterprise operation management client and the driver service client, and linkage management information is outputted as set in the emergency plan.

The traffic industry management client software is configured for driver identity verification management, driver authorization supervision, and driver and passenger file management. The driver identity verification management can receive the driver identity verification result, and perform statistics and query. The driver authorization supervision can receive and display the driver identity verification alarm information, supervise the driver's authority to drive the vehicle, and provide emergency authorization to the driver. The driver and passenger file management can manage the files of drivers and passengers. The file management content includes the name, the gender, the ID number, the company name, the qualification certificate number, the validity period of qualification certificate, and the personnel type.

The emergency industry management client software is configured for driver identity verification management. The driver identity verification management can receive the driver and passenger identity verification result, and perform statistics and query.

The another industry management client software (such as the insurance industry management client software) is configured for driver identity verification management. The driver identity verification management can receive the driver and passenger identity verification result, and perform statistics and query. The another industry management client software supports customization of functions based on the management requirements of the corresponding industry or supports users to choose to enable or disable the relevant monitoring client functions within their authorities.

Further, the enterprise operation management client in the remote management unit includes at least a carrier unit management client. In the case of the specified driver management on freight vehicles, the enterprise operation management client includes consignor unit management client software, carrier unit management client software, and consignee unit management client software, depending on different users.

The consignor unit management client software is configured for driver identity information query, which supports to query the identity information and the qualification certificate of the driver of the current transportation or the escort person of the dangerous goods transport vehicle corresponding to the electronic waybill number, and the identity verification result of the current transportation.

The carrier unit management client software is configured for driver identity verification management, driver authorization supervision, and driver and passenger file management. The driver identity verification management can receive the driver identity information and the identity verification result, and perform identity verification and comparison analysis on the received driver and passenger identity information and the driver and passenger file information of the unit or the electronic waybill scheduling information. In the case that the driver identity verification passes, and the driver identity information is consistent with the driver and passenger file information of the unit or the electronic waybill scheduling information, the drive permission command is issued, so that the vehicle can start and operate normally. In the case that the driver identity verification fails, or the driver identity information is inconsistent with the driver and passenger file information of the unit or the electronic waybill scheduling information, the drive non-permission command is issued, so that the vehicle cannot start and operate normally; and at the same time, the warning information is sent to the driver and passenger service client by using text, image, voice, file, or the like. In the case that the driver identity verification fails, or the driver identity information is inconsistent with the driver and passenger file information of the unit or the electronic waybill scheduling information, and the vehicle is started and operated abnormally, an emergency alarm prompt is displayed and the corresponding unit of the vehicle device is controlled to issue audible and visual alarm information from inside or outside the vehicle. The driver identity verification management of the carrier unit management client supports remote authorization to the driver and remote emergency activation of the vehicle ACC, and further supports the statistics, analysis, and query on the received driver and passenger identity verification result and the comparison verification result between the driver and passenger identity information and the driver and passenger file information or the electronic waybill scheduling information. The driver and passenger file management can manage the files of drivers or escorts of dangerous goods transport vehicles, and other passengers. The file management content includes the information, such as the name, the gender, the ID number, the employment qualification certificate number, the validity period of qualification certificate, the personnel type, the personnel's registered residence address, the actual residential address, the family member condition, the main social relations. The driver and passenger file management supports querying, adding, deleting, and editing the file content of drivers and passengers. When adding, deleting, and editing the file information content of drivers and passengers, a prompt message is sent to the driver and passenger service client. The modified content takes effect after the person who is added or deleted or the person who has edited the file information content logs in to confirm the modification. In addition, the driver and passenger file management supports drivers and passengers to submit editing applications such as addition, deletion and modification through the driver and passenger service client, and confirm the addition, deletion and modification of the driver and passenger file information through the carrier unit management client.

The consignee unit management client software is configured for driver identity information query, which supports to query the identity information and the qualification certificate of the driver of the current transportation or the escort person of the dangerous goods transport vehicle corresponding to the electronic waybill number or the tracking number, and the identity verification result of the current transportation.

Further, the driver and passenger service client in the remote management unit includes at least driver service client software. In the case of the freight vehicle transport where an escort is explicitly required or the passenger vehicle transport where a safety officer is explicitly required, the driver and passenger service client includes driver service client software and escort (safety officer) service client software, depending on different users.

The driver service client software is configured for driver identity verification and verification abnormality alarm. The driver identity verification can receive the identity document information and the biometric information of the driver, and the identity verification result. In the case that the identity verification passes, and the information of the driver acquired on site is consistent with the driver and passenger file information of the unit to which the driver belongs and the electronic waybill scheduling information, a drive permission command sent by the carrier unit management client is received and broadcast by voice, to prompt the driver to normally start and operate the vehicle. In the case that the person-document consistency verification fails, or the information of the driver acquired on site is inconsistent with the authorized driver file information of the unit to which the driver belongs or the electronic waybill scheduling information, a drive non-permission command sent by the carrier unit management client is received and broadcast by voice, and the voice prompt is issued to prompt the driver to adjust the posture for re-verifying the document.

The escort (safety officer) service client software is configured for driver identity verification abnormality alarm. In the case that the person-document consistency verification based on the information of the driver acquired on site fails or the information acquired on site is inconsistent with the authorized person file information of the unit to which the driver belongs or the electronic waybill scheduling information, the driver identity verification abnormality alarm is received, and the escort (safety officer) is prompted to send verification information to his/her unit after confirming the actual situation.

Further, the communication center in the remote management unit includes a cloud platform, a local server, and a personal mobile intelligent terminal.

The cloud platform is configured to store the data information uploaded by the driver identity verification unit; store the authorized driver database information; perform intelligent analysis, identification, and determination on the data information uploaded by the driver identity verification unit; provided a shared data resource pool for data reception and calling by the government industry management client software, the enterprise operation management client software, or the driver and passenger service client software; support the computer hardware platform environment for applying the government industry management client software, the enterprise operation management client software, or the driver and passenger service client software; and support communication interaction between the government industry management client software, the enterprise operation management client software, or the driver and passenger service client software and the vehicle gateway unit. The cloud platform communicates with the vehicle gateway unit, to receive and store the driver identity document acquisition result, the driver biometric information acquisition result, or the identity verification result forwarded by the driver identity verification unit through the vehicle gateway unit. In the case that the biometric information comparison component is disposed in cloud platform, the cloud platform performs the biometric information comparison, and forwards the management command or the response command of the government industry management client software, the enterprise operation management client software, and the driver and passenger service client software to the vehicle gateway unit.

The local server is configured to store the data information uploaded by the driver identity verification unit separately; store the authorized driver database information; perform intelligent analysis, identification, and determination on the data information uploaded by the driver identity verification unit; provide data resource for data reception and calling by the government industry management client software, the enterprise operation management client software, or the driver and passenger service client software; support the computer hardware platform environment for applying the government industry management client software, the enterprise operation management client software, or the driver and passenger service client software; and support communication interaction between the government industry management client software, the enterprise operation management client software, or the driver and passenger service client software and the vehicle gateway unit. The local server communicates with the vehicle gateway unit, to receive and store the driver identity document acquisition result, the driver biometric information acquisition result, or the identity verification result forwarded by the driver identity verification unit through the vehicle gateway unit. In the case that the biometric information comparison component is disposed in the local server, the local server performs the biometric information comparison, and forwards the management command or the response command of the government industry management client software, the enterprise operation management client software, and the driver and passenger service client software to the vehicle gateway unit.

The personal hand-held intelligent terminal is configured to be an online query tool and a temporary storage space for the data information uploaded by the driver identity verification unit, support the computer hardware platform environment for applying the government industry management client software, the enterprise operation management client software, or the driver and passenger service client software; and support communication interaction between the government industry management client software, the enterprise operation management client software, or the driver and passenger service client software and the vehicle gateway unit. The personal hand-held intelligent terminal communicates with the vehicle gateway unit through the cloud platform or the local server, to receive the driver identity document acquisition result, the driver biometric information acquisition result, or the identity verification result forwarded by the driver identity verification unit through the vehicle gateway unit, and forward the management command or the response command of the government industry management client software, the enterprise operation management client software, and the driver and passenger service client software to the vehicle gateway unit.

Further, the remote management unit is disposed in a cloud platform and/or a local storage server and/or a personal hand-held intelligent terminal of a relevant management person of a vehicle transportation related government department, or in a cloud platform and/or a local storage server and/or a personal hand-held intelligent terminal of a relevant management person of a vehicle transportation enterprise and a transportation related party, or in a personal hand-held intelligent terminal of a driver and passenger. The remote management unit is associated with the vehicle gateway unit. The remote management unit receives the driver identity verification result sent by the vehicle gateway unit, and generates the control command for vehicle management and driver management, or receives the driver identity information acquisition result sent by the vehicle gateway unit, performs comparison identification on the identity information of the driver or the consistency between the identity information and the biometric information, or the relevant identity information, the biometric information and the official file database information, and the file information of the unit to which the driver belongs, and generates the control command for driver management and driver management. The control command is sent to the vehicle gateway unit, and is then sent to the alarm prompt unit or the vehicle control unit through the vehicle gateway unit, so as to issue the audible and visual alarm, the voice prompt, or control the vehicle.

The specified driver management system based on biometric identification technology according to the present disclosure can perform person-document consistency verification based on the biometric identification technology and perform the authorized identity verification, and control the start permission of the vehicle and/or generate a safety warning to an illegal driver according to the specified driver identity verification result. This provides effective early warning and active intervention of potential accident risks caused by drivers, thereby improving the driving safety of the vehicle.

The specified driver management system according to the present disclosure can bind the driver identity with the drive permission of the specified operating vehicle and the start permission of the specific vehicle, thereby guaranteeing the driving safety of the vehicle from the perspective of drivers.

The remote management unit in the specified driver management system according to the present disclosure can help the system to realize overall safety monitoring function. In addition, it can provide basis and specific solutions for transportation related enterprise operation management units, such as carrier units, consignor units, consignee units, to carry out the driver identity management, and provide evaluation and management basis for government industry management departments, such as the public security organ, the traffic management department, and the emergency management department, to carry out the driver identity management and the driver safety condition management. Through the efforts of many parties and integration of advanced technologies, the driving safety hazards of the “Tourist Chartered Buses, Liner Buses, Dangerous Goods Transport Vehicles, Freight Vehicles, and School Buses” vehicles caused by drivers are eliminated. This effectively prevents and curbs the occurrence of serious accidents and traffic accidents that lead to group deaths and injuries, thereby protecting people and property safe, maintaining national stability, and ensuring social harmony.

### BRIEF DESCRIPTION OF THE DRAWINGS

The present disclosure is further described in combination with the attached drawings and the specific embodiments.

FIG. 1 is a schematic diagram of an architecture and a use process of a specified driver management system based on biometric identification technology according to an embodiment of the present disclosure.

FIG. 2 is a schematic diagram of a driver identity document reading sub-unit in a driver identity verification unit according to an embodiment of the present disclosure.

FIG. 3 is a schematic diagram of a biometric information acquisition sub-unit in a driver identity verification unit according to an embodiment of the present disclosure.

FIG. 4 is a schematic diagram of an architecture and a use process of a vehicle control unit according to an embodiment of the present disclosure.

FIG. 5 is a schematic diagram of an architecture of a vehicle gateway unit and a network communication module thereof according to an embodiment of the present disclosure.

FIG. 6 is a schematic diagram of an architecture and a use process of an alarm prompt unit according to an embodiment of the present disclosure.

FIG. 7 is a schematic diagram of an architecture and a use process of a remote management unit according to an embodiment of the present disclosure.

FIG. 8 is a schematic diagram of an architecture of a government industry management client in the remote management unit according to an embodiment of the present disclosure.

FIG. 9 is a schematic diagram of an architecture of an enterprise operation management client in the remote management unit according to an embodiment of the present disclosure.

FIG. 10 is a schematic diagram of an architecture of a driver and passenger service client in the remote management unit according to an embodiment of the present disclosure.

FIG. 11 is a schematic diagram of an architecture of a communication center in the remote management unit according to an embodiment of the present disclosure.

### DETAILED DESCRIPTION

In order to facilitate clear understanding of the technical means, creative features, objectives, and effects of the present disclosure, the present disclosure will be further described below with reference to the specific illustrations.

However, according to the transportation industry standards JT/T 794-2019, Global Navigation Satellite System (GNSS) for operating vehicles-Technical specifications for vehicle terminals, the driver identity confirmation is only carried out through the driver identity identification using an IC card qualification certificate of the driver, without verifying whether the certificate is in the possession of the driver. Therefore, there is a risk that an unqualified driver uses another driver's IC card qualification certificate to illegally drive the operating vehicles. In addition, the freight vehicles and the passenger vehicles with 7 or more seats that take students receiving compulsory education to and from school, key control objects in the transportation industry and need strict monitoring, are equipped with no vehicle terminal. Therefore, it is impossible to verify and confirm the driver identity, resulting in a large number of major traffic accidents or serious safety accidents caused by unauthorized drivers illegally driving vehicles.

In view of this, the present disclosure considers from the perspective of driver identity management. Specifically, the present disclosure uses the biometric identification, the cloud computing, the Internet of Things, and some other emerging technologies to directly confirm the authorized driver identity, so as to help the relevant industry departments, the vehicle, and the driver's unit to keep track of the driver's real identity in real time, and links the authorized driver identity verification result to the start permission of the vehicle, so as to eliminate safety hazards caused by unauthorized drivers, thereby ensuring the driving safety from the perspective of driver identity management.

Accordingly, the present disclosure provides a specified driver management system based on biometric identification technology. The management system performs dual identity verifications, including on-site person-document consistency verification based on biometric identification technology and identity verification on the driver information acquired on site and the authorized driver database information, and controls the start permission of the vehicle according to the authorized driver identity verification result, thereby providing effective warning and active intervention of potential accident risks caused by an unauthorized driver illegally driving the vehicle. This prevents the operating vehicles, such as “Tourist Chartered Buses, Liner Buses, Dangerous Goods Transport Vehicles, Freight Vehicles, and School Buses” vehicles, from traffic accidents due to factors such as driver qualification, ability, or malicious damage.

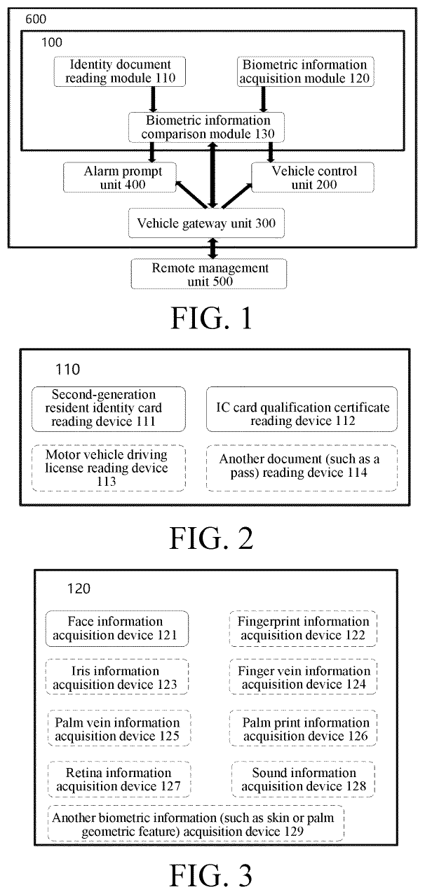

Referring to FIG. 1, it is a schematic diagram of an overall architecture of a specified driver management system based on biometric identification technology according to an embodiment of the present disclosure.

Based on FIG. 1, the specified driver management system mainly includes a driver identity verification unit 100, a vehicle control unit 200, a vehicle gateway unit 300, an alarm prompt unit 400, and a remote management unit 500 that are in cooperation with one another.

Based on FIG. 1, the driver identity verification unit 100 in the present system is disposed in a cab of a vehicle 600. The driver identity verification unit 100 is associated with the vehicle gateway unit 300, the alarm prompt unit 400, and the vehicle control unit 200, and may be associated with the remote management unit 500 through the vehicle gateway unit 300.

The driver identity verification unit 100 may acquire document information and biometric information of a current driver.

The driver identity verification unit 100 may, by itself, store the acquired identity information and biometric information of the current driver, as well as identify information and corresponding biometric information of an authorized driver.

The driver identity verification unit 100 may store the acquired document information and biometric information of the current driver, as well as the identify information and the corresponding biometric information of the authorized driver in a data storage module of the vehicle gateway unit 300. Alternatively, the driver identity verification unit 100 may wirelessly upload the acquired document information and biometric information of the current driver to the remote management unit through a network communication module in the vehicle gateway unit 300, and the remote management unit stores the identify information and the corresponding biometric information of the authorized driver.

The driver identity verification unit 100 may, by itself, perform consistency comparison between the biometric information in the acquired document information of the driver and the biometric information acquired on site, and perform comparison verification with the information of the authorized driver; or may, by an edge computing module in the vehicle gateway unit, perform consistency comparison between the biometric information in the acquired document information of the driver and the biometric information acquired on site, and perform comparison verification with the information of the authorized driver; or may, by the remote management unit, perform consistency comparison between the biometric information in the acquired document information of the driver and the biometric information acquired on site, and perform comparison verification with the information of the authorized driver. Then, the driver identity verification unit 100 may control a working state of a vehicle start system according to the verification result.

As an example, the vehicle 600 may be any of the operating vehicles, such as the “Tourist Chartered Buses, Liner Buses, Dangerous Goods Transport Vehicles, Freight Vehicles, and School Buses” vehicles.

Based on FIG. 1, the driver identity verification unit 100 in the specified driver management system mainly includes an identity document reading sub-unit 110, a biometric information acquisition sub-unit 120, and a biometric information comparison sub-unit 130 that are in cooperation with one another.

The identity document reading sub-unit 110 is configured to obtain the identity information of the document held by the current driver and the biometric information in the document chip or on the document surface, and send the identity information of the document held by the current driver and the biometric information in the document chip or on the document surface to the biometric information comparison sub-unit 130 in the driver identity verification unit 100, or a biometric information comparison function module (such as a corresponding edge computing module) in the vehicle gateway unit 300, or a biometric information comparison function module in the remote management unit 500 through the vehicle gateway unit 300.

The biometric information acquisition sub-unit 120 is configured to obtain the biometric information of the current driver, and send the obtained information to the biometric information comparison sub-unit 130 in the driver identity verification unit 100, or the biometric information comparison function module (such as the corresponding edge computing module) in the vehicle gateway unit 300, or the biometric information comparison function module in the remote management unit 500 through the vehicle gateway unit 300.

The biometric information comparison sub-unit 130 is configured to compare and verify the obtained biometric information corresponding to the identity information of the document held by the driver with the biometric information of the current driver, to determine whether the information belong to the same person and belong to the authorized driver.

Based on FIG. 1, the driver identity verification unit 100 with this configuration uses the identity document reading sub-unit 110 to acquire the document information of the current driver, uses the biometric information acquisition sub-unit 120 to acquire the biometric information of the current driver, and uses the biometric information comparison sub-unit 130 to perform consistency comparison between the document information of the driver acquired by the identity document reading sub-unit 110 and the biometric information of the driver acquired by the biometric information acquisition sub-unit 120, and perform comparison verification with the identity information of the authorized driver and the corresponding biometric information stored in the biometric information comparison sub-unit 130 and/or in the vehicle gateway unit 300 and/or in the remote management unit 500. Only after the consistency comparison between the biometric identification information in the document information acquired on site and the biometric identification information of the driver acquired on site passes, the comparison verification on the identity information and the biometric identification information acquired on site and the identity information and the biometric identification information of the authorized drivers can be started.

When the biometric information comparison sub-unit 130 performs the driver identity verification, the driver identity verification unit 100 generates a corresponding vehicle control command, such as a vehicle start command, according to the authorized driver identity verification result.

As an example, in the case that the driver identity verification passes, the driver identity verification unit 100 may directly send start permission command information to the vehicle control unit 200, or send start permission command information to the vehicle gateway unit 300, to allow the vehicle gateway unit 300 to forward the start permission command information to the vehicle control unit 200. In this way, after receiving the corresponding control command, the vehicle control unit 200 can activate the vehicle ACC according to the command.

In the case that the driver identity verification fails, the driver identity verification unit 100 may directly send start non-permission command information to the vehicle control unit 200, and send audible and visual information as well as voice prompt information to the alarm prompt unit 400. Alternatively, the driver identity verification unit 100 may send start non-permission command information, audible and visual information, and voice prompt information to the vehicle gateway unit 300, so that the vehicle gateway unit 300 forwards the start non-permission command information to the vehicle control unit 200, and forwards the audible and visual alarm information and the voice prompt information to the alarm prompt unit 400.

In this way, the vehicle control unit 200 synchronously deactivates the vehicle ACC after receiving the start non-permission command information. In addition, according to the received audible and visual alarm information and/or the voice prompt information, the alarm prompt unit 400 synchronously issues an audible and visual alarm and/or a voice prompt for indicating the verification failure, to prompt the driver to adjust the posture for re-acquiring the biometric information and re-verifying the document.

The driver identity verification unit 100 uploads the verification result and the vehicle start condition to the remote management unit 500 through the vehicle gateway unit 300 after the identity verification is finished.

It should be noted that the driver identity verification unit 100 in the specified driver management system may not include the biometric information comparison sub-unit 130; instead, the driver identity verification unit 100 realizes the driver identity verification by cooperating with the remote management unit 500. For example, the remote management unit 500 includes a corresponding biometric database and a comparison identification component, to achieve remote biometric information comparison.

In this case, during the driver identity verification, the driver identity verification unit 100 in the specified driver management system may use the identity document reading sub-unit 110 to acquire the identity document information of the current driver, and use the biometric information acquisition sub-unit 120 to acquire the biometric information of the current driver. After acquiring the corresponding information, the acquired information is uploaded to the remote management unit 500 through the vehicle gateway unit 300. The remote management unit 500 performs comparison identification on the biometric information, and sends the verification result back to the vehicle gateway unit 300. Then, the vehicle gateway unit 300 sends the command to the vehicle control unit 200.

In this way, in the case that the verification passes, the remote management unit 500 sends the start permission command to the vehicle control unit 200 through the vehicle gateway unit 300. In the case that the verification fails, the remote management unit 500 sends the start non-permission command to the vehicle control unit 200 through the vehicle gateway unit 300, and sends the alarm for indicating the verification failure to the alarm prompt unit 400 through the vehicle gateway unit 300, to prompt the driver to adjust the posture for re-acquiring the biometric information and verifying the document.

In a special state, the remote management unit 500 may issue a dedicated command to the driver identity verification unit 100 through the vehicle gateway unit 300, to perform remote emergency authorization to the driver or emergency activation of the vehicle ACC.

Based on FIG. 1, the vehicle control unit 200 in the system is disposed in the cab of the vehicle 600. The vehicle control unit 200 is associated with the driver identity verification unit 100 and the vehicle gateway unit 300, and is associated with the remote management unit 500 through the vehicle gateway unit 300.

The vehicle control unit 200 is disposed in the cab of the vehicle, and is linked to the vehicle start system. The vehicle control unit 200 is associated with the vehicle gateway unit 300 and the driver identity verification unit 100, and is associated with the alarm prompt unit 400, the remote management unit 500, and/or the driver identity verification unit 100 through the vehicle gateway unit 300.

The vehicle control unit 200 is able to control whether to start the vehicle according to the driver identity verification result sent by the driver identity verification unit 100 or the vehicle gateway unit 300.

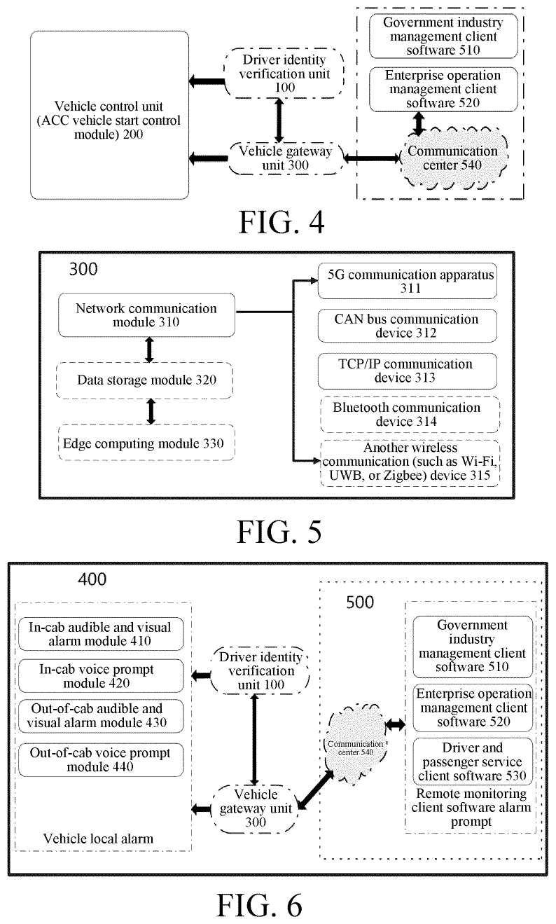

FIG. 4 shows a schematic diagram of an architecture and a use process of the vehicle control unit 200 in the specified driver management system according to an embodiment.

Based on FIG. 4, the vehicle control unit 200 according to this embodiment includes an ACC vehicle start control module.

Based on FIG. 1 and FIG. 4, the vehicle control unit 200 with this configuration may use the ACC vehicle start control module to receive the driver identity verification result sent by the driver identity verification unit 100, or forwarded by the driver identity verification unit 100 through the vehicle gateway unit 300, or forwarded by the government industry management client software 510 through the communication center 540 and the vehicle gateway unit 300, or forwarded by the enterprise operation management client software 520 through the vehicle gateway unit 300; and determine whether the vehicle is permitted to start. The vehicle is permitted to start in the case that the driver identity verification result is passed, and the vehicle is not permitted to start in the case that the driver identity verification result is failed.

The vehicle control unit 200 is preferably directly associated with the driver identity verification unit 100 and the vehicle gateway unit 300 during application deployment. In this way, in the case that the vehicle control unit 200 receives the result that the driver identity verification passes, or receives the result that the driver identity verification passes forwarded by the driver identity verification unit 100 through the vehicle gateway unit 300, the vehicle control unit 200 controls the vehicle ACC to be activated; in the case that the vehicle control unit 200 receives the result that the driver identity verification fails, the vehicle control unit 200 controls the vehicle ACC to be deactivated; and in the case that the vehicle control unit 200 receives the result that the driver state detection is abnormal, the vehicle control unit 200 controls the vehicle to perform speed limitation, speed reduction or emergency braking. This achieves different types of precise control over the vehicle in different situations, thereby effectively ensuring the driving safety.

Based on FIG. 1, the vehicle gateway unit 300 in the present system is disposed in the cab of the vehicle 600. The vehicle gateway unit 300 is associated with the driver identity verification unit 100, the alarm prompt unit 400, the vehicle control unit 200, and the remote management unit 500.

The vehicle gateway unit 300 at least has a network communication function, and/or a data storage function, and/or an edge computing function. It establishes a communication channel with the remote management unit 500, to perform comparison, identification, and analysis on the data information generated by the driver identity verification unit 100, or transmit the relevant information to the remote management unit for comparison, identification, and analysis, and transmit the management data information returned by the remote management unit to the vehicle control unit and the alarm prompt unit.

Referring to FIG. 5, it shows a schematic diagram of an architecture and a network communication module thereof in the specified driver management system according to an embodiment.

Based on FIG. 5, the vehicle gateway unit 300 in the specified driver management system according to this embodiment includes a network communication module 310, a data storage module 320, and/or an edge computing module 330 that are in combination with one another or independent from one another. The network communication module 310 is the basic component, namely, the necessary component of the vehicle gateway unit 300.

Based on FIG. 1 and FIG. 5, the vehicle gateway unit 300 with this configuration uses the network communication module 310 to perform data exchange between the driver identity verification unit 100 and the alarm prompt unit 400, the vehicle control unit 200, and the remote management unit 500, so that the identity document reading data, the biometric information acquisition data, or the identity verification result information uploaded by the driver identity verification unit 100 is forwarded to the remote management unit 500, or the corresponding command is sent to the vehicle control unit 200 and the alarm prompt unit 400 according to the received driver identity verification result information.

The vehicle gateway unit 300 may send the corresponding command to the vehicle control unit 200 and the alarm prompt unit 400 according to the driver identity verification result obtained by the edge computing module 330 in the vehicle gateway unit 300; or forward the management command received from the remote management unit 500 to the driver identity verification unit 100, the alarm prompt unit 400, or the vehicle control unit 200.

The vehicle gateway unit 300 may use the data storage module 320 to store the identity document reading data and the biometric information acquisition data uploaded by the driver identity verification unit 100, or the identity information database and the biometric information database of authorized drivers.

The vehicle gateway unit 300 may use the edge computing module 330 to perform comparison verification on the identity document reading data and the biometric information acquisition data uploaded by the driver identity verification unit 100, and perform comparison verification with the information in the identity information database and the biometric information database of authorized drivers.

Based on FIG. 1, the alarm prompt unit 400 in the present system is disposed in the cab of the vehicle, or outside the vehicle, or in the monitoring client software of the remote management unit 500. The alarm prompt unit 400 is associated with the driver identity verification unit 100, the driver state monitoring unit 200, the vehicle gateway unit 300, and the remote management unit 500.

The alarm prompt unit 400 includes a local audible and visual alarm device or a voice prompt device, and a remote monitoring client alarm display setting. The local audible and visual alarm device or the voice prompt device in the alarm prompt unit 400 is disposed inside the cab of the vehicle or outside the vehicle, and is connected to the driver identity verification unit 100 and the vehicle gateway unit 300 separately. The local alarm prompt unit with this configuration can issue a voice prompt or an audible and visual alarm according to the driver identity verification result sent by the driver identity verification unit 100 or the vehicle gateway unit 300.

The remote monitoring client alarm display setting in the alarm prompt unit 400 is disposed in the government industry management client software, the enterprise operation management client software, and the driver and passenger service client software in the remote management unit, and is connected to the vehicle gateway unit 300. The monitoring client in the alarm prompt unit with this configuration issues a voice or text prompt according to the driver identity verification result or the driver state monitoring determination result sent by the vehicle gateway unit 300.

FIG. 6 shows a schematic diagram of an architecture and a use process of the alarm prompt unit 400 in the specified driver management system according to an embodiment.

Based on FIG. 6, the alarm prompt unit 400 in the specified driver management system according to this embodiment includes vehicle local alarm prompt sub-units, such as an in-cab audible and visual alarm module 410, an in-cab voice prompt module 420, an out-of-cab audible and visual alarm module 430, and an out-of-cab voice prompt module 440, as well as remote monitoring client software alarm prompt sub-units, such as the government industry management client software 510, the enterprise operation management client software 520, and the driver and passenger service client software 530, which are in mutual cooperation with one another.

Based on FIG. 1 and FIG. 6, the in-cab audible and visual alarm module 410 in the alarm prompt unit 400 with this configuration is configured to issue an audible and visual alarm in the case that the driver identity verification fails. As an example, the light emitted by the audible and visual alarm of the audible and visual alarm module is typically red by default.

The in-cab voice prompt module 420 is configured to prompt the driver to start the vehicle in the case that driver identity verification passes, and prompt the driver to adjust the posture for re-verification in the cast that the driver identity verification fails. As an example, the in-cab voice prompt module 420 and the in-cab audible and visual alarm module may be independently disposed or may be combined to form a voice and audible-visual alarm device.

The out-of-cab audible and visual alarm module 430 is configured to issue an audible and visual alarm to the crowd outside the vehicle in the case that the driver identity verification fails multiple times, or the vehicle ACC is forcibly activated without the driver identity verification under a non-emergency authorization state. As an example, the light emitted by the audible and visual alarm of the audible and visual alarm module is typically red by default, and the volume of the alarm sound is sufficient to alert pedestrians in noisy road environments.

The out-of-cab voice prompt module 440 is configured to issue a voice prompt to the crowd outside the vehicle in the case that the driver identity verification fails multiple times, or the vehicle ACC is forcibly activated without the driver identity verification under a non-emergency authorization state. As an example, the volume of the voice prompt and the volume of the alarm sound generated by the out-of-cab voice prompt module 440 are sufficient to alert pedestrians in noisy road environments. The audio prompt content is broadcast clearly enough to make listeners understood.

The government industry management client software 510 is configured to receive the alarm information forwarded by the vehicle gateway through the communication center in the case that the driver identity verification fails.

The enterprise operation management client software 520 is configured to receive the alarm information forwarded by the vehicle gateway through the communication center in the case that the driver identity verification fails.

The driver and passenger service client 530 is configured to receive the alarm information forwarded by the vehicle gateway through the communication center in the case that the driver identity verification fails, and at the same time, issue the voice prompt with the content set according to different user roles of the driver and passenger service client, such as prompting the driver to adjust the posture for re-verification. As an example, the driver and passenger service client issues the alarm information and the voice prompt at the same time, where the voice prompt content varies depending on the user role of the driver and passenger service client. For example, the driver service client issues a voice prompt for prompting the driver to adjust the posture for re-verification; the escort service client of the hazardous chemical transportation vehicles issues a voice prompt for prompting the escort to confirm the actual situation and send verification information to the his/her unit; and the safety officer service client of long-distance passenger vehicles or school buses issues a voice prompt for prompting the safety officer to confirm the actual situation and send verification letters to his/her unit.

Based on FIG. 1, the remote management unit 500 in the present system is disposed in a cloud platform and/or a local storage server and/or a personal hand-held intelligent terminal of a relevant management person of a vehicle transportation related government department, or in a cloud platform and/or a local storage server and/or a personal hand-held intelligent terminal of a relevant management person of a vehicle transportation enterprise and a transportation related party, or in a personal hand-held intelligent terminal of a driver and passenger. The remote management unit 500 is associated with the vehicle gateway unit 300, and associated with the driver identity verification unit 100, the alarm prompt unit 400, and the vehicle control unit 200 through the vehicle gateway unit 300.

During operation, the remote management unit 500 receives the driver identity verification result sent by the vehicle gateway unit 300, and generates the control command for driver management and driver management; or receives the driver identity information acquisition result sent by the vehicle gateway unit 300, and performs comparison identification on the identity information of the driver, or the consistency between the identity information and the biometric information, or the relevant identity information, the biometric information, the official file database information, and the file information of the unit to which the driver belongs, and generates the control command for driver management and driver management. The control command is sent to the vehicle gateway unit 300, and is then sent to the alarm prompt unit 400 or the vehicle control unit 200 through the vehicle gateway unit 300, so as to issue the audible and visual alarm, the voice prompt, or control the vehicle ACC to be activated or deactivated.

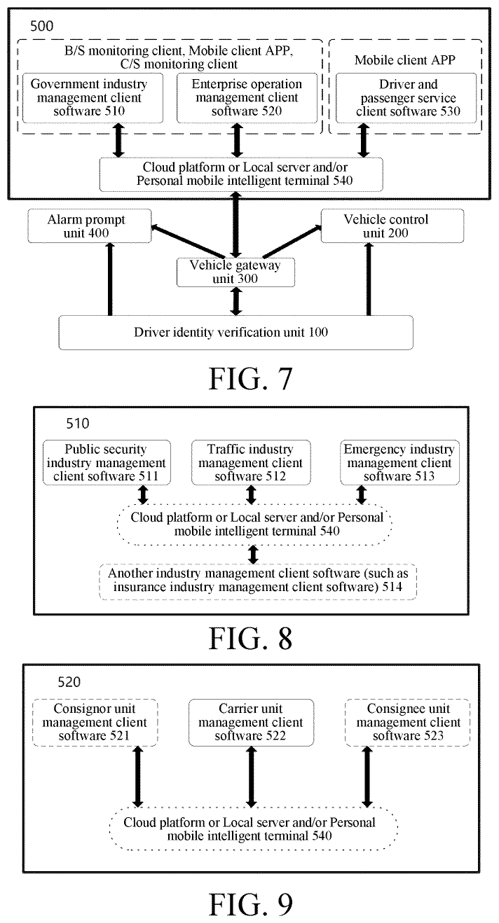

Referring to FIG. 7, it shows a schematic diagram of an architecture and a use process of the remote management unit 500 in the specified driver management system according to an embodiment.

Based on FIG. 7, the remote management unit 500 according to this embodiment includes the government industry management client software 510, the enterprise operation management client software 520, the driver and passenger service client software 530, and the communication center 540 (such as, a cloud platform, or a local server, and/or a personal mobile intelligent terminal) that are in cooperation with one another.

Based on FIG. 1 and FIG. 7, the remote management unit 500 with this configuration may use the government industry management client software 510 to receive and display the driver identity document acquisition result, the driver biometric information acquisition result, and the identity verification result sent by the driver identity verification unit 100 or forwarded by the driver identity verification unit 100 through the vehicle gateway unit 300 and through the communication center 540, and perform supplementary content identity verification according to the driver identity document acquisition result and the driver biometric information acquisition result.

The remote management unit 500 may use the enterprise operation management client software 520 to receive and display the driver identity document acquisition result, the driver biometric information acquisition result, and the identity verification result sent by the driver identity verification unit 100 or forwarded by the driver identity verification unit 100 through the vehicle gateway unit 300 and through the communication center 540, and perform supplementary content identity verification according to the driver identity document acquisition result and the driver biometric information acquisition result.

The remote management unit 500 may use the driver and passenger service client software 530 to receive and display the identity verification result sent by the driver identity verification unit 100 or forwarded by the driver identity verification unit 100 through the vehicle gateway unit 300 and through the communication center 540, and issue a vehicle start prompt or a posture adjust prompt for re-verification according to the driver identity verification result.

The remote management unit 500 may use the communication center 540 to communicate with the vehicle gateway unit 300, to receive and store the driver identity document acquisition result, the driver biometric information acquisition result, or the identity verification result forwarded by the driver identity verification unit 100 through the vehicle gateway unit 300. In the case that the biometric information comparison component is disposed in the remote management unit 500, the biometric information comparison may be performed by the cloud platform or the local server in the communication center 540.

In addition, the communication center 540 serves as the computer system environment for the government industry management client software 510, the enterprise operation management client software 520, and the driver and passenger service client software 530, to support relevant software applications, and forwards the management command or the response command of the government industry management client software 510, the enterprise operation management client software 520, and the driver and passenger service client software 530 to the vehicle gateway unit 300.

On this basis, the present disclosure further describes the specific devices that may be involved in the composition modules of each unit of the vehicle transportation safety monitoring system based on driver management.

FIG. 2 shows a schematic structural diagram of the driver identity document reading sub-unit 110 in the driver identity verification unit in the specified driver management system based on biometric identification technology according to an embodiment.

Based on FIG. 2, the identity document reading sub-unit 110 in the driver identity verification unit 100 in the specified driver management system according to this embodiment includes but is not limited to a second-generation resident identity card reading device 111, an IC card qualification certificate reading device 112, and/or a motor vehicle driving license reading device 113, and/or another document (such as a pass) reading device 114. The specific device types are determined according to the requirements of management work, which are not limited herein. Under normal circumstances, the identity document reading sub-unit 110 includes at least the second-generation resident identity card reading device 111. For the operating vehicle that requires the drivers to own qualification certificates, the identity document reading sub-unit 110 includes at least the second-generation resident identity card reading device 111 and the IC card qualification certificate reading device 112.

Based on this configuration, the identity document reading sub-unit 110 may use the second-generation resident identity card reading device 111 to read second-generation resident identity cards of drivers. The form of the second-generation resident identity card reading device 111 includes but is not limited to an external independent resident identity reader, an embedded resident identity card reading module, or a built-in resident identity card reading component in an intelligent terminal. The details are determined based on the installation condition of the vehicle, which are not limited herein.

The identity card reading sub-unit 110 may use the IC card qualification certificate reading device 112 to read IC card qualification certificates of staffs working on road transport, such as travel drivers, staffs working on dangerous goods transport, passenger and cargo transport drivers, and some taxi drivers. The specific form of the IC card qualification certificate reading device 112 includes but is not limited to a radio frequency identification (RFID) reader or an intelligent hand-held terminal with the near field communication (NFC) function that reads chip information of the IC card qualification certificate, a code scanner or an intelligent hand-held terminal with the two-dimensional code scanning function that reads surface two-dimensional code information of the IC card qualification certificate, a license acquisition instrument or an intelligent hand-held terminal with the optical character recognition (OCR) function that reads surface text information of the IC card qualification certificate. The details are determined according to the installation condition of the vehicle, which are not limited herein.

The identity document reading sub-unit 110 may use the motor vehicle driving license reading device 113 to read motor vehicle driving licenses owned by drivers. The form of the motor vehicle driving license reading device 113 includes but is not limited to a RFID reader or an intelligent hand-held terminal with the NFC function that reads the surface quick response (QR) code information of the motor vehicle driving license, a scanner or an intelligent hand-held terminal with QR code scanning function that reads the surface text information of the motor vehicle driving license, a license acquisition device that reads the surface text information of the motor vehicle driving license, or an intelligent hand-held terminal with the OCR function. The details are determined according to the installation condition of the vehicle, which are not limited herein.

The identity document reading sub-unit 110 uses the another document (such as the pass) reading device 114 to read another document held by the driver, such as the pass. The form of the another document (such as the pass) reading device 114 is determined based on the state of the read document. It includes but is not limited to a RFID reader or an intelligent hand-held terminal with the NFC function that reads chip information of the document, a code scanner or an intelligent hand-held terminal with the two-dimensional code scanning function that reads surface two-dimensional code information of the document, a license acquisition instrument or an intelligent hand-held terminal with the OCR function that reads surface text information of the document. The details are determined according to the installation condition of the vehicle, which are not limited herein.

Further, referring to FIG. 3, it shows a schematic structural diagram of the biometric information acquisition sub-unit 120 in the driver identity verification unit in the specified driver management system according to an embodiment.

Based on FIG. 3, the biometric information acquisition sub-unit 120 in the driver identity verification unit 100 in the specified driver management system according to this embodiment includes but is not limited to a face information acquisition device 121, a fingerprint information acquisition device 122, an iris information acquisition device 123, a finger vein information acquisition device 124, a palm vein information acquisition device 125, a palm print information acquisition device 126, a retina information acquisition device 127, a sound information acquisition device 128, and another biometric information (such as skin or palm geometric feature) acquisition device 129. The details are determined according to the requirements of the relevant government industry regulatory departments, and are not limited herein. It is preferable to use the non-contact biometric feature acquisition mode, such as the face information acquisition device 121, the iris information acquisition device 123, the retina information acquisition device 127, and the sound information acquisition device 128.

The biometric information acquisition sub-unit 120 may use the face information acquisition device 121 to acquire frontal face information of the driver. The specific form of the face information acquisition device 121 includes but is not limited to an external video capture camera and an embedded video capture camera. The specific type of the face information acquisition device 121 includes but is not limited to a visible light video capture camera, a near-infrared video capture camera, a dedicated camera or a three-dimensional face acquisition instrument for acquiring three-dimensional face information. The details are determined according to the installation condition of the vehicle and the management requirements of the carrier unit, which are not limited herein.

The biometric information acquisition sub-unit 120 may use the fingerprint information acquisition device 122 to acquire fingerprint information of the driver. The form of the fingerprint information acquisition device 122 includes but is not limited to an external fingerprint collector, an embedded fingerprint acquisition component. The specific type of the fingerprint information acquisition device 122 includes but is not limited to an optical fingerprint collector, a thermal fingerprint collector, and a biometric radio frequency fingerprint collector. The details are determined according to the installation condition of the vehicle and the management requirements of the carrier unit, which are not limited herein.

The biometric information acquisition sub-unit 120 may use the iris information acquisition device 123 to acquire iris information of the driver. The specific form of the iris information acquisition device 123 includes but is not limited to an external iris collector and an embedded iris collector. The type of the iris information acquisition devices 123 includes but is not limited to a monocular iris acquisition instrument (collector) and a binocular iris acquisition instrument (collector). The details are determined according to the installation condition of the vehicle and the management requirements of the carrier unit, which are not limited herein.

The biometric information acquisition sub-unit 120 may use the finger vein information acquisition device 124 to acquire finger vein information of the driver. The specific form of the finger vein information acquisition device 124 includes but is not limited to an external finger vein collector and an embedded finger vein acquisition component. The type of the finger vein acquisition device 124 includes but is not limited to a single finger vein collector and a composite collector of finger vein plus finger print. The details are determined according to the installation condition of the vehicle and the management requirements of the carrier unit, which are not limited herein.

The biometric information acquisition sub-unit 120 may use the palm vein information acquisition device 125 to acquire palm vein information of the driver. The specific form of the palm vein information acquisition device 125 includes but is not limited to an external desktop palm vein collector, an external hand-held palm vein collector, and an embedded palm vein acquisition component. The type of the palm vein information acquisition device 125 includes but is not limited to a single palm vein collector and a composite collector of palm vein plus palm print. The details are determined according to the installation condition of the vehicle and the management requirements of the carrier unit, which are not limited herein.

The biometric information acquisition sub-unit 120 may use the palm print information acquisition device 126 to acquire palm print information of the driver. The specific form of the palm print information acquisition device 126 includes but is not limited to an external desktop palm print collector, an external hand-held palm print collector, and an embedded palm print acquisition component. The type of the palm print information acquisition device 126 includes but is not limited to a single palm print collector and a composite collector of palm print plus palm vein. The details are determined according to the installation condition of the vehicle and the management requirements of the carrier unit, which are not limited herein.

The biometric information acquisition sub-unit 120 may use the retina information acquisition device 127 to acquire retina information of the driver. The specific form of the retina information acquisition device 127 includes but is not limited to an external retina acquisition instrument and an embedded retina collector. The type of retina information acquisition device 127 includes but is not limited to a monocular retina acquisition instrument (collector) and a binocular retina acquisition instrument (collector). The details are determined according to the installation condition of the vehicle and the management requirements of the carrier unit, which are not limited herein.

The biometric information acquisition sub-unit 120 may use the sound information acquisition device 128 to acquire sound information of the driver. The specific form of the sound information acquisition device 128 includes but is not limited to an external sound acquisition instrument and an embedded sound collector. The type of the sound information acquisition device 128 includes but is not limited to a microphone, a mic, and a pickup. The details are determined according to the installation condition of the vehicle and the management requirements of the carrier unit, which are not limited herein.

The biometric information acquisition sub-unit 120 may use the another biometric information (such as the skin or palm geometric feature) acquisition device 129 to acquire the another biometric information of the driver, such as living body feature information inside the driver's skin, physical feature information of the driver's palm and finger. The specific form of the another biometric information (such as the skin or palm geometric feature) acquisition device 129 includes but is not limited to an external acquisition instrument for the another biometric information (such as the skin or palm geometric feature) and an embedded collector for the another biometric information (such as the skin or palm geometric feature). The type of the another biometric information (such as the skin or palm geometric feature) acquisition device 129 includes but is not limited to a skin light printing collector and a hand shape reader. The details are determined according to the installation condition of the vehicle and the management requirements of the carrier unit, which are not limited herein.

Correspondingly, the biometric information comparison sub-unit 130 in the driver identity verification unit in this embodiment specifically includes but is not limited to a face information comparison device, a fingerprint information comparison device, an iris information comparison device, a finger vein information comparison device, a palm vein information comparison device, a palm print information comparison device, a retina information comparison device, a sound information comparison device, or another biometric information (such as the skin or palm geometric feature) comparison device.

The face information comparison device is configured to perform 1:1 comparison verification on the digital face photo in the chip of the read identify document or any other document and/or the face image on the document surface and the face image information of the driver acquired on site, perform 1:1 comparison verification on the face image information of the driver acquired on site and the face information corresponding to the read identity in the database, and/or perform 1:N comparison verification on the face image information of the driver acquired on site and the face information of all authorized drivers in the database.

The form of the face information comparison device includes but is not limited to an authorized person face database and a comparison identification component built in the identity verification unit, an authorized person face database and a comparison identification component in the vehicle gateway unit, and an authorized person face database and a comparison identification component in the remote management unit. The details are determined according to the installation condition of the vehicle and the management requirements of the carrier unit, which are not limited herein.

The fingerprint information comparison device is configured to perform 1:1 comparison verification on the fingerprint information in the chip of the read identity document or any other document and the fingerprint information of the driver acquired on site, perform 1:1 comparison verification on the fingerprint information of the driver acquired on site and the fingerprint information corresponding to the read identity in the database, and/or perform 1:N comparison verification on the fingerprint information of the driver acquired on site and the fingerprint information of all authorized drivers in the database.

The form of the fingerprint information comparison device includes but is not limited to an authorized person fingerprint database and a comparison identification component built in the identity verification unit, an authorized person fingerprint database and a comparison identification component in the vehicle gateway unit, and an authorized person fingerprint database and a comparison identification component in the remote management unit. The details are determined according to the installation condition of the vehicle and the management requirements of the carrier unit, which are not limited herein.

The iris information comparison device is configured to perform 1:1 comparison verification on the iris information (if any) in the chip of the read identity document or any other document and the iris information of the driver acquired on site, and/or perform 1:1 comparison verification on the iris information of the driver acquired on site and the iris information corresponding to the read identity in the database, and/or perform 1:N comparison verification on the iris information of the driver acquired on site and the iris information of all authorized drivers in the database.

The form of the iris information comparison device includes but is not limited to an authorized person iris database and a comparison identification component built in the identity verification unit, an authorized person iris database and a comparison identification component in the vehicle gateway unit, and an authorized person iris database and a comparison identification component in the remote management unit. The details are determined according to the installation condition of the vehicle and the management requirements of the carrier unit, which are not limited herein.

The finger vein information comparison device is configured to perform 1:1 comparison verification on the finger vein information (if any) in the chip of the read identity document or any other document and the finger vein information of the driver acquired on site, and/or perform 1:1 comparison verification on the finger vein information of the driver acquired on site and the finger vein information corresponding to the read identity in the database, and/or perform 1:N comparison verification on the finger vein information of the driver acquired on site and the finger vein information of all authorized drivers in the database. The form of the finger vein information comparison device includes but is not limited to an authorized person finger vein database and a comparison identification component built in the identity verification unit, an authorized person finger vein database and a comparison identification component in the vehicle gateway unit, and an authorized person finger vein database and a comparison identification component in the remote management unit. The details are determined according to the installation condition of the vehicle and the management requirements of the carrier unit, which are not limited herein.

The palm vein information comparison device is configured to perform 1:1 comparison verification on the palm vein information (if any) in the chip of the read identity document or any other document and the palm vein information of the driver acquired on site, and/or perform 1:1 comparison verification on the palm vein information of the driver acquired on site and the palm vein information corresponding to the read identity in the database, and/or perform 1:N comparison verification on the palm vein information of the driver acquired on site and the palm vein information of all authorized drivers in the database. The form of the palm vein information comparison device includes but is not limited to an authorized person palm vein database and a comparison identification component built in the identity verification unit, an authorized person palm vein database and a comparison identification component in the vehicle gateway unit, and an authorized person palm vein database and a comparison identification component in the remote management unit. The details are determined according to the installation condition of the vehicle and the management requirements of the carrier unit, which are not limited herein.

The palm print information comparison device is configured to perform 1:1 comparison verification on the palm print information (if any) in the chip of the read identity document or any other document and the palm print information of the driver acquired on site, and/or perform 1:1 comparison verification on the palm print information of the driver acquired on site and the palm print information corresponding to the read identity in the database, and/or perform 1:N comparison verification on the palm print information of the driver acquired on site and the palm print information of all authorized drivers in the database.

The form of the palm print information comparison device includes but is not limited to an authorized person palm print database and a comparison identification component built in the identity verification unit, an authorized person palm print database and a comparison identification component in the vehicle gateway unit, and an authorized person palm print database and a comparison identification component in the remote management unit. The details are determined according to the installation condition of the vehicle and the management requirements of the carrier unit, which are not limited herein.

The retina information comparison device is configured to perform 1:1 comparison verification on the retina information (if any) in the chip of the read identity document or any other document and the retina information of the driver acquired on site, and/or perform 1:1 comparison verification on the retina information of the driver acquired on site and the retina information corresponding to the read identity in the database, and/or perform 1:N comparison verification on the retina information of the driver acquired on site and the retina information of all authorized drivers in the database.

The form of the retina information comparison device includes but is not limited to an authorized person retina database and a comparison identification component built in the identity verification unit, an authorized person retina database and a comparison identification component in the vehicle gateway unit, and an authorized person retina database and a comparison identification component in the remote management unit. The details are determined according to the installation condition of the vehicle and the management requirements of the carrier unit, which are not limited herein.

The sound information comparison device is configured to perform 1:1 comparison verification on the sound information feature (if any) in the chip of the read identity document or any other document and the sound information feature of the driver acquired on site, and/or perform 1:1 comparison verification on the sound information feature of the driver acquired on site with the sound information feature corresponding to the read identity in the database, and/or perform 1:N comparison verification on the sound information feature of the driver acquired on site with the sound information features of all authorized drivers in the database.

The form of the sound information comparison device includes but is not limited to an authorized person sound database and a comparison identification component built in the identity verification unit, an authorized person sound database and a comparison identification component in the vehicle gateway unit, and an authorized person sound database and a comparison identification component in the remote management unit. The details are determined according to the installation condition of the vehicle and the management requirements of the carrier unit, which are not limited herein.

The comparison device for another biometric information such as the skin or palm geometric feature is configured to perform 1:1 comparison verification on the another biometric information (if any) such as the skin or palm geometric feature in the chip of the read identity document or any other document and the another biometric information such as the skin or palm geometric feature of the driver acquired on site, and/or perform 1:1 comparison verification on the another biometric information such as the skin or palm geometric feature of the driver acquired on site with the another biometric information such as the skin or palm geometric feature corresponding to the read identity in the database, and/or perform 1:N comparison verification on the another biometric information such as the skin or palm geometric feature of the driver acquired on site with the another biometric information such as the skin or palm geometric feature of all authorized drivers in the database.

The form of the comparison device for another biometric information such as the skin or palm geometric feature includes but is not limited to a database of another biometric information such as the skin or palm geometric feature of authorized persons and a comparison identification component built in the identity verification unit, a database of another biometric information such as the skin or palm geometric feature of authorized persons and a comparison identification component in the vehicle gateway unit, and a database of another biometric information such as the skin or palm geometric feature of authorized persons and a comparison identification component in the remote management unit. The details are determined according to the installation condition of the vehicle and the management requirements of the carrier unit, which are not limited herein.

The driver identity verification unit 100, which is constituted by the identity document reading sub-unit 110, the biometric information acquisition sub-unit 120, and the biometric information comparison sub-unit 130 that are in cooperation with one another, may be directly associated with the vehicle control unit or may be indirectly associated with the vehicle control unit and/or the remote management unit through the vehicle gateway unit during deployment.

In the case that the driver identity verification unit 110 is directly associated with the vehicle control unit 200, the switch of the vehicle ACC can be activated normally after the specified driver identity verification passes; otherwise, the switch of the vehicle ACC cannot be activated normally, and the alarm prompt unit 400 issues the verification failure alarm and prompts the driver to adjust the posture for re-acquiring the biometric feature. The verification result and the vehicle start condition are uploaded to the remote management unit 500 through the vehicle gateway unit 300.

In the case that the driver identity verification unit 110 is indirectly associated with the vehicle control unit 200 through the vehicle gateway unit 300, the vehicle gateway unit 300 sends the command to the vehicle control unit 200 after the driver identity verification result is generated. In the case that the verification passes, the switch of the vehicle ACC can be activated normally; otherwise, the switch of the vehicle ACC cannot be activated normally, and the alarm prompt unit 400 issues the verification failure alarm and prompts the driver to adjust the posture for re-acquiring the biometric feature. The verification result and the vehicle start condition are uploaded to the remote management unit 500 through the vehicle gateway unit 300.

In the case that the driver identity verification unit 110 is indirectly associated with the vehicle control unit 200 through the vehicle gateway unit 300, and the biometric database and the comparison identification component are in the remote management unit, the identity document reading information and the biometric acquisition information of the driver are uploaded to the remote management unit 500 through the vehicle gateway unit 300. The remote management unit 500 sends the verification result to the vehicle gateway unit 300 after performing the comparison identification on the biometric information. The vehicle gateway unit 300 sends the command to the vehicle control unit 200. The switch of the vehicle ACC can be activated normally in the case that the verification passes; otherwise, the switch of the vehicle ACC cannot be activated normally. The alarm prompt unit 400 sends the verification failure alarm and prompts the driver to adjust the posture for re-acquiring the biometric feature. The vehicle start condition is uploaded to the remote management unit 500 through the vehicle gateway unit 300.

In a special state, the driver identity verification unit 110 supports remote emergency authorization through the remote management unit.

FIG. 5 shows a schematic diagram of an architecture and a network communication module thereof in the specified driver management system according to an embodiment.

Based on FIG. 5, the network communication module 310 in the vehicle gateway unit 300 in the specified driver management system according to this embodiment includes a 5G communication device 311, a CAN bus communication device 312, a TCP/IP communication device 313, a Bluetooth communication device 314, and another wireless communication (such as WI-FI, UWB, or Zigbee) device 315.

The network communication module 310 may use the 5G communication device 311 to realize communication between the vehicle gateway unit 300 and the remote management unit 500.

The network communication module 310 may use the CAN bus communication device 312 to realize wired communication between the vehicle gateway unit 300 and the driver identity verification unit 100, the vehicle control unit 200, and the alarm prompt unit 400 in a CAN bus mode.

The network communication module 310 may use the TCP/IP communication device 313 to realize wired or wireless communication between the vehicle gateway unit 300 and the driver identity verification unit 100, the alarm prompt unit 400, the vehicle control unit 200, and the remote management unit 500 in a TCP/IP mode.

The network communication module 310 may use the Bluetooth communication device 314 to realize wireless communication based on the Bluetooth protocol between the vehicle gateway unit 300 and the driver identity verification unit 100, and the alarm prompt unit 400. The network communication module 310 may use the another wireless communication (such as WI-FI, UWB, or Zigbee) device 314 to realize wireless communication based on the corresponding protocol such as WI-FI, UWB, or Zigbee between the vehicle gateway unit 300 and the driver identity verification unit 100, and the alarm prompt unit 400.

Preferably, the network communication module 310 in this embodiment includes at least the 5G communication device 311, the CAN bus communication device 312, and the TCP/IP communication device 313. The configuration of the another wireless communication device is determined based on the specific communication mode used by the camera, the sensor, the document acquisition device, or the biometric acquisition device mounted on the vehicle, which is not limited herein.

Based on FIG. 5, the data storage module 320 in the vehicle gateway unit 300 in the specified driver management system according to this embodiment includes a built-in data storage device and an external data storage device.

The built-in data storage device is configured to store the identity document reading data and the biometric information acquisition data uploaded by the driver identity verification unit, or the identity information database and the biometric information database of authorized drivers. The built-in data storage device specifically includes but is not limited to a built-in static SRAM, a built-in RAM, a built-in hard disk, and a built-in ROM. The built-in ROM is configured to store the identity information database and the biometric information database of authorized drivers.

The external data storage device includes but is not limited to an external mobile hard disk, a USB flash disk, a TF memory card, a SD memory card, a CD-RW, a DVD-RAM disc, a non-rewritable CD-ROM, a DVD-ROM disc. The non-rewritable CD-ROM and the DVD-ROM disc are configured to store the identity information database and the biometric information database of authorized drivers.

Based on FIG. 5, the edge computing module 330 in the vehicle gateway unit 300 in the specified driver management system according to this embodiment includes an AI smart chip with an edge computing function or a terminal SDK with edge computing.

The circuit board AI smart chip with the edge computing function or the terminal SDK with edge computing is configured to perform comparison verification on the identity document reading data and the biometric information acquisition data uploaded by the driver identity verification unit with the information in the identity information database and the biometric information database of authorized drivers.

Therefore, the vehicle gateway unit 300, which is constituted by the network communication module 310, the data storage module 320, and the edge computing module 330, may be directly associated with the driver identity verification unit 100, the vehicle control unit 200, the alarm prompt unit 400, and the remote management unit 500 during specific deployment.

Upon receiving the result that the driver identity verification passes, the vehicle gateway unit 300 sends a command to the vehicle control unit 200 to control the vehicle ACC to be activated, and forwards the driver identity verification result and the action information of the vehicle control unit to the remote management unit 500.

Upon receiving the result that the driver identity verification fails, the vehicle gateway unit 300 sends a command to the vehicle control unit 200 to control the vehicle ACC to be deactivated, sends a command to the alarm prompt unit 400 to prompt the driver to adjust the posture for re-verification, and sends the driver identity verification result and the action information of the vehicle control unit to the remote management unit 500.

Further, with reference to FIG. 6, the alarm prompt unit 400 in this embodiment may be directly associated with the driver identity verification unit 100 and the vehicle gateway unit 300 during specific deployment.

In the case that the vehicle local alarm prompt sub-unit receives the result that the driver identity verification fails sent by the driver identity verification unit 100 or sent by the driver identity verification unit 100 through the vehicle gateway unit 300, the alarm prompt unit 400 issues the audible and visual alarm, and prompts the driver to adjust the posture for re-verification by voice.

In the case that the remote monitoring client software alarm prompt sub-unit receives the result that the driver identity verification fails sent by that the driver identity verification unit 100 through the vehicle gateway unit 300 and through the communication center 540, the alarm prompt unit 400 issues the alarm prompt.

Further, referring to FIG. 8, it shows a schematic diagram of an architecture of the government industry management client 510 in the remote management unit in the specified driver management system according to an embodiment.

Based on FIG. 8, the government industry management client 510 in the remote management unit 500 in the specified driver management system according to this embodiment includes public security industry management client software 511, traffic industry management client software 512, emergency industry management client software 513, and another industry management client software 514 (such as insurance industry management client software), depending on different industry departments.

The public security industry management client software 511 in the government industry management client 510 is configured for driver identity verification management and driver identity management.

The driver identity verification management can receive the driver and passenger identity verification result, and perform statistics and query. The driver identity management can receive the driver identify information and the identity verification result, and perform comparison analysis with the motor vehicle driving license file information in the public security organ. In the case that the driver identify information or the quasi-driving type is inconsistent with the driving license file information, or the quasi-driving type of the motor vehicle driving license corresponding to the driver identify information does not include the quasi-driving type required by the professional qualification, an alarm is issued by using text, image, voice, or file, to output warning information to the enterprise operation management client and the driver service client, and linkage management information is outputted as set in the emergency plan.

The traffic industry management client software 512 in the government industry management client 510 is configured for driver identity verification management, driver authorization supervision, and driver and passenger file management.

The driver identity verification management can receive the driver identity verification result, and perform statistics and query. The driver authorization supervision can receive and display the driver identity verification alarm information, supervise the driver's authority to drive the vehicle, and provide emergency authorization to the driver. The driver and passenger file management can manage the files of drivers and passengers such as the drivers or the escorts of hazardous material transportation vehicles. The file management content includes the name, the gender, the ID number, the company name, the qualification certificate number, the validity period of qualification certificate, and the personnel type.

The emergency industry management client software 513 in the government industry management client 510 is configured for driver identity verification management.

The driver identity verification management can receive the driver and passenger identity verification result, and perform statistics and query.

The another industry management client software 514 (such as the insurance industry management client software) in the government industry management client 510 is configured for driver identity verification management. The driver identity verification management can receive the driver and passenger identity verification result, and perform statistics and query.

The another industry management client software further supports customization of functions based on the management requirements of the corresponding industry or supports users to choose to enable or disable the relevant monitoring client functions within their authorities. The details are not limited herein.

FIG. 9 shows a schematic diagram of an architecture of the enterprise operation management client 520 in the remote management unit in the specified driver management system according to an embodiment.

Based on FIG. 9, the enterprise operation management client 520 in the remote management unit 500 in the specified driver management system according to this embodiment may include consignor unit management client software 521, carrier unit management client software 522, and consignee unit management client software 523, depending on different users. For the operating vehicles such as chartered buses for travel and the linear buses of class III or above, the enterprise operation management client 520 may only include the carrier unit management client software 522.

The consignor unit management client software 521 in the enterprise operation management client 520 is configured for driver identity information query. As an example, for a road special vehicle for transporting hazardous chemicals, fireworks, or civilian explosives, the software supports querying the identity information and the qualification certificate of the current driver corresponding to the electronic waybill number or the escort of the dangerous goods transportation vehicle, and the current driver verification result.

The carrier unit management client software 522 in the enterprise operation management client 520 is configured for driver identity verification management, driver authorization supervision, and driver and passenger file management.

As an example, the driver identity verification management can receive the driver identity information and the identity verification result, and perform identity verification and comparison analysis on the received driver and passenger identity information and the driver and passenger file information of the unit or the electronic waybill scheduling information. In the case that the driver identity verification passes, and the driver identity information is consistent with the driver and passenger file information of the unit or the electronic waybill scheduling information, the drive permission command is issued, so that the vehicle can start and operate normally. In the case that the driver identity verification fails, or the driver identity information is inconsistent with the driver and passenger file information of the unit or the electronic waybill scheduling information, the drive non-permission command is issued, so that the vehicle cannot start and operate normally; and at the same time, the warning information is sent to the driver and passenger service client by using text, image, voice, file, or the like. In the case that the driver identity verification fails, or the driver identity information is inconsistent with the driver and passenger file information of the unit or the electronic waybill scheduling information, and the vehicle is started and operated abnormally, the emergency alarm prompt is displayed and the corresponding unit of the vehicle device is controlled to send the audible and visual alarm information from inside or outside the vehicle. The driver identity verification management of the carrier unit management client supports remote authorization to the driver and remote emergency activation of the vehicle ACC, and further supports the statistics, analysis, and query on the received driver and passenger identity verification result and the comparison verification result between the driver and passenger identity information and the driver and passenger file information or the electronic waybill scheduling information.

The driver and passenger file management can manage the files of drivers or escorts of dangerous goods transport vehicles, and other passengers. The file management content includes the information such as the name, the gender, the ID number, the employment qualification certificate number, the validity period of qualification certificate, the personnel type, the personnel's registered residence address, the actual residential address, the family member condition, the main social relations. The driver and passenger file management supports querying, adding, deleting, and editing the file content of drivers and passengers. When adding, deleting, and editing the file information content of drivers and passengers, a prompt message is sent to the driver and passenger service client. The modified content takes effect after the person who is added or deleted or the person who has edited the file information content logs in to confirm the modification. In addition, the driver and passenger file management supports drivers and passengers to submit editing applications such as addition, deletion and modification through the driver and passenger service client, and confirm the addition, deletion and modification of the driver and passenger file information through the carrier unit management client.

The receiving unit management client software 523 in the enterprise operation management client 520 is configured for driver document information query. As an example, for a road special vehicle for transporting hazardous chemicals, fireworks, or civilian explosives, the receiving unit management client software 523 supports querying the identity information and the qualification certificate of the current driver corresponding to the electronic waybill number or the escort of the dangerous goods transportation vehicle, and the current driver verification result.

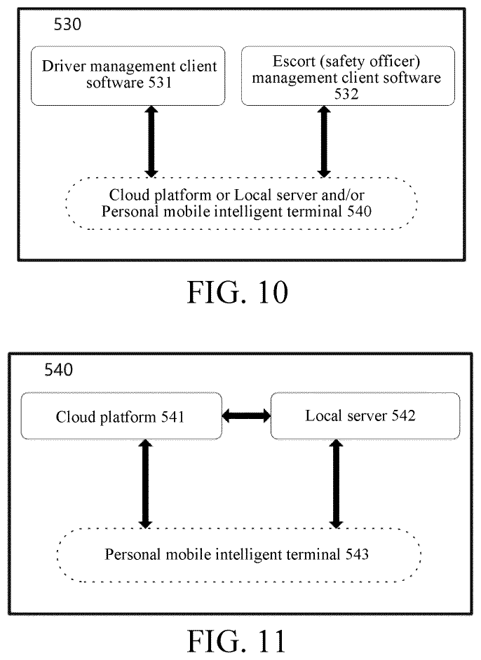

FIG. 10 shows a schematic diagram of an architecture of the driver and passenger service client 530 in the remote management unit in the specified driver management system according to an embodiment.

Based on FIG. 10, the driver and passenger service client 530 in the remote management unit 500 in the specified driver management system according to this embodiment includes driver service client software 531 and escort (safety officer) service client software 532, depending on different users.

The driver service client software 531 in the driver and passenger service client 530 is configured for driver identity verification and verification abnormality alarm.

As an example, the driver identity verification can receive the identity document information and the biometric information of the driver, and the identity verification result. In the case that the identity verification passes, and the information of the driver is consistent with the driver and passenger file information of the unit to which the driver belongs or the electronic waybill scheduling information, a drive permission command sent by the carrier unit management client is received and broadcast by voice, to prompt the driver to normally start and operate the vehicle. In the case that the identity verification fails, or the information of the driver is inconsistent with the driver and passenger file information of the unit to which the driver belongs or the electronic waybill scheduling information, a drive non-permission command sent by the carrier unit management client is received and broadcast by voice, and the voice prompt is issued to prompt the driver to adjust the posture for re-verifying the document.

The escort (safety officer) service client software 532 in the driver and passenger service client 530 is configured for driver identity verification abnormality alarm.

As an example, the driver identity verification abnormality alarm can receive and display the person-document consistency comparison result of the driver and the comparison verification result of the specified driver data information. In the case that the person-document consistency verification based on the information of the driver acquired on site fails or the information acquired on site is inconsistent with the authorized driver file information of the unit to which the driver belongs or the electronic waybill scheduling information, the driver identity verification abnormality alarm is received, and the escort person (safety officer) is prompted to send verification information to his/her unit after confirming the actual situation.

Further referring to FIG. 11, it is a schematic diagram of an architecture of the communication center 540 in the remote management unit in the specified driver management system according to an embodiment.

Based on FIG. 11, the communication center 540 in the remote management unit 500 in the specified driver management system according to this embodiment includes a cloud platform 541, a local server 542, and a personal mobile intelligent terminal 543.

In this embodiment, the communication center preferably uses the way in which the cloud platform is combined with the personal mobile intelligent terminal. The details are specifically determined based on actual communication conditions of different users, which are not limited herein.

The cloud platform 541 in the communication center 540 is configured to store the data information uploaded by the driver identity verification unit 100; store the authorized driver database information; perform intelligent analysis, identification, and determining on the data information uploaded by the driver identity verification unit 100; provided a shared data resource pool for data reception and calling by the government industry management client software 510, the enterprise operation management client software 520, or the driver and passenger service client software 530; support the computer hardware platform environment for applying the government industry management client software 510, the enterprise operation management client software 520, or the driver and passenger service client software 530; and support communication interaction between the government industry management client software 510, the enterprise operation management client software 520, or the driver and passenger service client software 530 and the vehicle gateway unit 300.

The cloud platform 541 communicates with the vehicle gateway unit 300, to receive and store the driver identity document acquisition result, the driver biometric information acquisition result, or the identity verification result forwarded by the driver identity verification unit 100 through the vehicle gateway unit 300. In the case that the biometric information comparison component is disposed in cloud platform 541, the cloud platform 541 performs the biometric information comparison, and forwards the management command or the response command of the government industry management client software 510, the enterprise operation management client software 520, and the driver and passenger service client software 530 to the vehicle gateway unit 300.

The cloud platform 541 supports applications of a browser/server (B/S) monitoring client. The B/S monitoring client is developed based on the latest version of China's high secure operating system and the Xinchuang browser with high security.

The local server 542 in the communication center 540 is configured to store the data information uploaded by the driver identity verification unit 100 separately; store the authorized driver database information; perform intelligent analysis, identification, and judgment on the data information uploaded by the driver identity verification unit 100; provide data resource for data reception and calling by the government industry management client software 510, the enterprise operation management client software 520, or the driver and passenger service client software 530; support the computer hardware platform environment for applying the government industry management client software 510, the enterprise operation management client software 520, or the driver and passenger service client software 530; and support communication interaction between the government industry management client software 510, the enterprise operation management client software 520, or the driver and passenger service client software 530 and the vehicle gateway unit 300.

The local server 542 communicates with the vehicle gateway unit 300, to receive and store the driver identity document acquisition result, the driver biometric information acquisition result, or the identity verification result forwarded by the driver identity verification unit 100 through the vehicle gateway unit 300.

In the case that the biometric information comparison component is disposed in the local server 542, the local server 542 performs the biometric information comparison, and forwards the management command or the response command of the government industry management client software 510, the enterprise operation management client software 520, and the driver and passenger service client software 530 to the vehicle gateway unit 300.

The local server 542 supports applications of a client/server (C/S) monitoring client. The C/S monitoring client is developed based on the latest version of high secure operating system of Linux kernel.

The personal hand-held intelligent terminal 543 in the communication center 540 is served as an online query tool and a temporary storage space for the data information uploaded by the driver identity verification unit 100. It is configured to support the computer hardware platform environment for applying the government industry management client software 510, the enterprise operation management client software 520, or the driver and passenger service client software 530; and support communication interaction between the government industry management client software 510, the enterprise operation management client software 520, or the driver and passenger service client software 530 and the vehicle gateway unit 300.

The personal hand-held intelligent terminal 543 communicates with the vehicle gateway unit 300 through the cloud platform 541 or the local server 542, to receive the driver identity document acquisition result, the driver biometric information acquisition result, or the identity verification result forwarded by the driver identity verification unit 100 through the vehicle gateway unit 300, and forward the management command or the response command of the government industry management client software 510, the enterprise operation management client software 520, and the driver and passenger service client software 530 to the vehicle gateway unit 300.

The personal hand-held intelligent terminal 543 supports applications of a mobile monitoring client. The mobile monitoring client is developed based on the operating system based on the Linux kernel such as Harmony OS micro-kernel or Linux.

The remote management unit 500, which is constituted by the government industry management client software 510, the enterprise operation management client software 520, the driver and passenger service client software 530, and the communication center 540, is disposed in the cloud platform and/or the local storage server and/or the personal hand-held intelligent terminal of a relevant management person of the vehicle transportation related government industry department, or the cloud platform and/or the local storage server and/or the personal hand-held intelligent terminal of a relevant management person of the vehicle transportation enterprise and a transportation related party, or the personal hand-held intelligent terminal of the driver and passenger. The remote management unit 500 is connected to the vehicle gateway unit 300.

In this way, the remote management unit 500 receives the driver identity verification result sent by the vehicle gateway unit 300, generates control command for vehicle management and driver management, or receives the driver identity information acquisition result sent by the vehicle gateway unit 300, and performs comparison identification on the driver identity information, or the consistency between the identity information and the biometric information, or the relevant identity information, the biometric information, the official file database information, and the enterprise file information, and generates the control command for vehicle management and driver management. The control command for vehicle management and driver management is sent to the vehicle gateway unit 300, and then sent to the vehicle control unit 200 or the alarm prompt unit 400 through the vehicle gateway unit 300, so as to issue the audible and visual alarm, the voice prompt, or control the vehicle ACC to be activated or deactivated.

During operation, the specified driver management system based on biometric identification technology can first verify the true identity of the driver of the current vehicle transportation, and bind the true identity information of the driver with the driving authority of the specified operating vehicle and the start permission of the current vehicle. This avoids the vehicle from being started and operated by a non-specified driver, so as to prevent uncontrollable traffic safety accidents, thereby ensuring the driving safety of automobile transportation from the source.

It should be noted that the method or the specific system units or parts thereof in the present disclosure may be stored by program codes in a physical medium, such as a hard disk, and optical disc, or any electronic device (such as a smart phone, a computer-readable storage medium). In the case that a machine (such as a smart phone) loads and executes the program codes, the machine is the device to implement the present disclosure. The method and device in the present disclosure may be transmitted in the form of program codes or any other form through a transmission medium, such as a cable, an optical fiber. In the case that a machine (such as a smart phone) receives, loads, and executes the program codes, the machine is the device to implement the present disclosure.

The basic principle, main features and advantages of the present disclosure are described above. Those skilled in the art should understand that the present disclosure is not limited by the foregoing embodiments. The foregoing embodiments and the description merely describe the principle of the present disclosure. Without deviating from the spirit and scope of the present disclosure, various changes and improvements can be made. These changes and improvements fall within the scope of the present disclosure. The scope of protection claimed by the present disclosure is defined by the attached claims and their equivalents.

What is claimed is:

1. A specified driver management system based on biometric identification technology, comprising:
a driver identity verification unit, the driver identity verification unit being able to acquire document information and biometric information of a current driver, on the basis of performing consistency comparison between the biometric information of the driver acquired on site and biometric information comprised in a chip or on a surface of a document read on site, perform secondary comparison verification on the document information and the biometric information of the current driver that has passed the on-site person-document consistency verification with driver identity information and biometric information stored in an authorized driver database, and control a working state of a vehicle start system according to a verification result;
a vehicle control unit, the vehicle control unit being linked to the vehicle start system, and being associated with the driver identity verification unit and a vehicle gateway unit, and the vehicle control unit being configured to control whether a vehicle is permitted to start according to a driver identity verification result sent by the driver identity verification unit or the vehicle gateway unit;
the vehicle gateway unit, the vehicle gateway unit being associated with the driver identity verification unit, the vehicle control unit, an alarm prompt unit, and a remote management unit respectively, and the vehicle gateway unit being able to perform driver identity verification in cooperation with the driver identity verification unit;
the alarm prompt unit, the alarm prompt unit being connected and cooperated with the driver identity verification unit and the vehicle gateway unit respectively; and
the remote management unit, the remote management unit being configured to perform the driver identity verification in cooperation with the driver identity verification unit through the vehicle control unit, and output a control command for vehicle management and driver management to the vehicle gateway unit.

2. The specified driver management system according to claim 1, wherein the driver identity verification unit comprises an identity document reading sub-unit, a biometric information acquisition sub-unit, and a biometric information comparison sub-unit;
the identity document reading sub-unit comprises a second-generation resident identity card reading device, an integrated circuit (IC) card qualification certificate reading device, a motor vehicle driving license reading device, and/or another document (for example, a pass) reading device; and the identity document reading sub-unit is configured to obtain identity information of the document held by the current driver, and send the obtained identity information of the held document to the biometric information comparison sub-unit in the driver identity verification unit, or a biometric information comparison sub-unit in the vehicle gateway unit, or a biometric information comparison sub-unit in the remote management unit through the vehicle gateway unit;
the biometric information acquisition sub-unit comprises a face information acquisition device, and/or a fingerprint information acquisition device, and/or an iris information acquisition device, and/or a finger vein information acquisition device, and/or a palm vein information acquisition device, and/or a palm print information acquisition device, and/or a retina information acquisition device, and/or a sound information acquisition device, or another biometric information acquisition device; and
the biometric information acquisition sub-unit is configured to obtain the biometric information of the current driver, and send the obtained information to the biometric information comparison sub-unit in the driver identity verification unit, or the biometric information comparison sub-unit in the vehicle gateway unit, or the biometric information comparison sub-unit in the remote management unit through the vehicle gateway unit;
the biometric information comparison sub-unit comprises a face information comparison device, and/or a fingerprint information comparison device, and/or an iris information comparison device, and/or a finger vein information comparison device, and/or a palm vein information comparison device, and/or a palm print information comparison device, and/or a retina information comparison device, and/or a sound information comparison device, or another biometric information comparison device; and the biometric information comparison sub-unit is configured to perform the on-site person-document consistency verification on the biometric information in the chip or on the surface of the document held by the driver and the biometric information of the current driver, to determine whether the information belongs to the same person, and perform the secondary specified driver comparison verification on the identity information and the biometric information of the document held by the current driver that has passed the on-site person-document consistency verification with the driver identity information and the biometric information stored in the authorized driver database in itself or the vehicle gateway unit or the remote management unit.

3. The specified driver management system according to claim 1, wherein the vehicle control unit comprises an adaptive cruise control (ACC) vehicle start control module; the ACC vehicle start control module is configured to determine whether the vehicle is permitted to start according to a received driver identity verification result; the vehicle is permitted to start in a case that the specified driver identity verification result is passed, and the vehicle is not permitted to start in a case that the specified driver identity verification result is failed; and the ACC vehicle start control module supports emergency start through the remote management unit.

4. The specified driver management system according to claim 1, wherein the vehicle gateway unit comprises a network communication module, and/or a data storage module, and/or an edge computing module;
the network communication module comprises one or more of a 5G communication device, a controller area network (CAN) bus communication device, a transmission control protocol/Internet protocol (TCP/IP) communication device, a Bluetooth communication device, and another wireless communication device; and the network communication module is configured for data exchange between the driver identity verification unit and the alarm warning unit, the vehicle control unit, and the remote management unit;
the data storage module comprises a built-in data storage device and an external data storage device; and the data storage module is configured to store data interacted between the driver identity verification unit and the alarm prompt unit, the vehicle control unit, and the remote management unit, and/or store authorized driver database information; and
the edge computing module comprises an artificial intelligence (AI) smart chip with an edge computing function and a terminal software development kit (SDK) with edge computing; and the edge computing module is configured to perform the on-site person-document consistency verification on the document information and the biometric information acquired by the driver identity verification unit, and perform comparison verification on the document information and the biometric information with relevant identity information and biometric identification information stored in an authorized driver database in the vehicle gateway unit.

5. The specified driver management system according to claim 1, wherein the alarm prompt unit comprises a vehicle local alarm prompt sub-unit and a remote monitoring client software alarm prompt sub-unit.

6. The specified driver management system according to claim 1, wherein the remote management unit comprises a government industry management client, an enterprise operation management client, a driver and passenger service client, and a communication center;
the remote management unit receives an on-site person-document consistency verification result of the driver and a specified driver identity verification result sent by the vehicle gateway unit, and generates the control command for vehicle management and driver management, or receives the identity information acquisition result of the driver sent by the vehicle gateway unit, performs consistency comparison between the identity information and the biometric information of the driver on site, and performs comparison identification on the identity information and the biometric information of the driver on site and identity information and biometric information of a specified driver stored in an authorized driver database, and generates the control command for vehicle management and driver management; and sends the control command to the vehicle gateway unit, so that the vehicle gateway unit sends the control command to the alarm prompt unit or the vehicle control unit, to issue an audible and visual alarm and a voice prompt, or control the vehicle.

7. The specified driver management system according to claim 6, wherein the government industry management client in the remote management unit comprises public security industry management client software, traffic industry management client software, emergency industry management client software, and another industry management client software, depending on different industry departments;
the public security industry management client software is configured for driver identity verification management and driver identity management;
the traffic industry management client software is configured for the driver identity verification management, driver authority supervision, and driver and passenger file management;
the emergency industry management client software is configured for the driver identity verification management; and
the another industry management client software is configured for the driver identity verification management.

8. The specified driver management system according to claim 6, wherein the enterprise operation management client in the remote management unit comprises consignor unit management client software, carrier unit management client software, and consignee unit management client software, depending on different users;
the consignor unit management client software is configured for driver identity information query;
the carrier unit management client software is configured for driver identity verification management, driver authority supervision, and driver and passenger file management; and
the consignee unit management client software is configured for the driver identity information query.

9. The specified driver management system according to claim 6, wherein the driver and passenger service client in the remote management unit comprises driver service client software and escort service client software, depending on difference users;
the driver service client software is configured for driver identity verification and verification abnormality prompt; and
the escort service client software is configured for driver identity verification abnormality alarm.

10. The specified driver management system according to claim 6, wherein the communication center in the remote management unit comprises a cloud platform, a local server, and a personal mobile intelligent terminal;
the cloud platform is configured to store data information uploaded by the driver identity verification unit; store authorized driver database information; perform intelligent analysis, identification, and determination on the data information uploaded by the driver identity verification unit; provided a shared data resource pool for data reception and calling by government industry management client software, enterprise operation management client software, or driver and passenger service client software; support a computer hardware platform environment for applying the government industry management client software, the enterprise operation management client software, or the driver and passenger service client software; and support communication interaction between the government industry management client software, the enterprise operation management client software, or the driver and passenger service client software and the vehicle gateway unit;
the local server is configured to store the data information uploaded by the driver identity verification unit separately; store the authorized driver database information; perform intelligent analysis, identification, and determination on the data information uploaded by the driver identity verification unit; provided data resource for data reception and calling by the government industry management client software, the enterprise operation management client software, or the driver and passenger service client software; support the computer hardware platform environment for applying the government industry management client software, the enterprise operation management client software, or the driver and passenger service client software; and support communication interaction between the government industry management client software, the enterprise operation management client software, or the driver and passenger service client software and the vehicle gateway unit; and
the personal hand-held intelligent terminal is configured to communicate with the vehicle gateway unit through the cloud platform or the local server, to receive a driver identity document acquisition result forwarded by the driver identity verification unit through the vehicle gateway unit, and forward a management command or a response command of the government industry management client software, the enterprise operation management client software, or the driver and passenger service client software to the vehicle gateway unit.
